(19) United States
(12) Patent Application Publication
(10) Pub. No.: US 2009/0167553 A1
(43) Pub. Date: Jul. 2, 2009

(54) Open Mobile Online Reservation and Ordering Systems

(76) Inventors: Jin Hong, Saratoga, CA (US); Qihong Nicki Zhang, Saratoga, CA (US)

Correspondence Address: Jin Hong, 19796 Bonnie Ridge Way, Saratoga, CA, 95070, US

(21) Appl. No.: 12/344,596

(22) Filed: Dec. 29, 2008

Related U.S. Application Data
(60) Provisional application No. 61/017,648, filed on Dec. 30, 2007.

(51) Int. Cl. G06Q 10/00

(52) U.S. Cl. 340/825.29

(57) ABSTRACT

The invention relates to a new “mobile and online based ordering and reservation system” by integrating, synchronizing and utilizing the capability of wireless devices, Internet servers, business web sites and service aggregation portals, to automate the mobile and online ordering and reservation processes in real time, and therefore offering a plural of new mobile and online services and applications.

More specifically, the Internet server serves as the host to the service aggregation and as the intermediary device between customers and business. It automatically synchronizes all of the service requests and responses. Therefore, this invention takes full advantage of the flexibility, mobility, availability and convenience of the wireless devices, and the reliability, scalability, the huge processing power of the Internet servers, and the great broadband penetration of the computers into businesses and consumers.

The unique and novel, mobile and online based ordering and reservation platform and system, for such time sensitive services, provides the mobile phone and Internet users and various types of business owners with comprehensive sets of options, including the mobile phones installed with the open source “Android” software platform developed by the “Open Handheld Alliance (OHA), such as the “gPhone” released by “Google”, to deliver the requests and responses automatically and instantly through means of synchronization between mobile and Internet communications. Based on the open source mobile phone platform and the Internet server infrastructure, an intuitive and easy-to-use mobile phone and online based ordering and reservation management system is uniquely defined in the architecture of the current invention to allow both the business owners and end consumers with real time communications for a plural of mobile and online ordering and reservation services.

This U.S. application is the official filing of the previously filed provisional U.S. patent application filed on Dec. 29, 2007, entitled “Open Mobile Reservation and Ordering System” by Jin Hong and Nicki Zhang from Saratoga, Calif., USA, and incorporated herein by reference.

### FIELD OF INVENTION

This invention relates to a plural of new services and new applications with the newly developed “mobile and online based ordering and reservation system” by integrating, synchronizing and utilizing the capability of wireless devices, Internet servers, business web sites and service aggregation portals, to automate the mobile and online ordering and reservation processes in real time fashion.

More specifically, in this invention, the Internet server serves as the host to the service aggregation and as the intermediary device between customers and business. It automatically synchronizes all of the services requests and responses in real time among the end consumers requesting for services and the businesses providing the requested services. The Internet server delivers business information directly to the customer computers or wireless devices. It receives, processes, forwards, and synchronizes all customer requests and all business responses, transfers message and data in between and updates status to both customers and businesses, all in real time automatically.

A plural of the newly proposed and developed services at the Internet server, as well as a plural of newly proposed and developed applications for the wireless devices and the Internet attached computers, all supported by a new way of synchronization between the Internet infrastructure and wireless networks forms the core of this invention.

This invention creates a plural of message states for each message communicated between the customer and the business owner. These different states are indications of the status of the customer request and business response so that it can be tracked and carefully handled by the Internet server. Therefore the communication between the customer and the business is not only real time, but also with many states control mechanism implemented to facilitate the communications and the understanding of the next actions to be taken.

This invention takes full advantage of the flexibility, mobility, availability and convenience of the wireless devices, and the reliability, scalability, the huge processing power of the Internet servers, and the great broadband penetration of the computers into businesses and consumers.

The unique and novel, mobile and online based ordering and reservation platform and system, for such time sensitive services, provides the mobile phone and Internet users and various types of business owners with comprehensive sets of options to deliver the requests and responses automatically and instantly through means of synchronization between mobile and Internet communications. It is noted that both the customers and the business owners can have many different options in choosing different means of communication devices when utilizing this invention for the requested or provided services. For customers, the most convenient options are mobile phones and computers. For business owners, more options are available such as mobile phones, computers, fax machines, and network attached printers.

Among the sets of available options to the mobile phone users and the business owners, are the mobile devices equipped with the “Android” software platform, which is an open source mobile phone platform based on the Linux operating system and developed by the Open Handset Alliance (OHA). One of the examples will be the release of mobile phone platform from the company like “Google”, the “gPhone” that comes with the “Android” software platform installed. Based on the open source mobile phone platform and the Internet server infrastructure, an intuitive and easy-to-use mobile phone and online based ordering and reservation management system is uniquely defined in the architecture of the current invention to allow both the business owners and end consumers for the real time communications, to request for ordering and reservation services and to respond accordingly to such services in real time.

The platform has many unique innovative features to address the ever demanding needs of mobile phone users and business owners, such as the distinct and the most advanced service features of mobile ordering sheet, mobile phone ordering items with dual language support, mobile ordering items with individual input notes and labels, mobile phone ordering, mobile phone ordering with discount or coupon, group or corporate mobile phone ordering, mobile catering or special ordering events, mobile phone reservation, mobile phone reservation with advanced ordering, mobile phone periodic statistical analysis report and billing report, mobile phone based web site hosting and automatic update for the business owners utilizing automated web site, generation with unified forms and consistent designs, automatic loading of mobile phone orderable items, self editing and self loading of mobile phone orderable items list, and etc.

This comprehensive mobile phone and computer based order and reservation system is intended for all industries and applications that are suitable and applicable. There is no limit where those systems shall be used efficiently and effectively.

In particular, this mobile phone and online based service platform and system is applied directly to the mobile phone based order and reservation to the restaurants, Pizza stores, and all food preparation and/or delivery business.

Nowadays, the society has become so dynamic and everyone is on the move most of the time. It will be hard for customers to find time to sit in front of computers and make the online reservation or online ordering. On the other hand, it will be hard for the restaurants to have a dedicated and highly educated employee to handle all the online services requests from the Internet users and then respond timely. Also, restaurants do not open all the time and they have time off between lunch and dinner as well. So the owners will not be able to respond to the online requests on time when they are not at work or physically in the restaurants. The consumers can send in the request any time, from anywhere, and would always like to get the response back as soon as possible. The need for the consumers to be able to make reservation or ordering at anytime, from anywhere, without being limited by the availability of the access to computers and the Internet, and getting the response back immediately is huge and ever increasing.

It is therefore highly demanded that people can use their mobile phone or smart phones to make time sensitive reservation or ordering to the business at the time of their need from anywhere they are, and get response back immediately.

It is the objective of this invention to design a convenient and flexible reservation and ordering request and response system for module phones, in particular, as one example only although not limited to if, based on the open mobile platform equipped with “Android” standard for the use for many service oriented industries such as for the restaurants, hotels, and etc.

### BACKGROUND OF THE INVENTION

The present invention is generally related to a comprehensive, unique, and novel mobile phone and online based ordering and reservation system.

More particularly, the present invention is related to the mobile and online ordering and reservation platform and system that can process and automate the mobile and online ordering and reservation requests and responses between the end consumers and the associated business owners, with the Internet servers that host ordering and reservation service aggregation web portal or individual's business service portal as the processing brain and relaying center.

The Internet server receives requests and data from both end consumers and/or business owners individually, processes requests and prepares necessary information from the dada base, and then sends the corresponding message back to either the end consumers or the business owners, or individually or both, on as needed or as requested basis. The Internet server is served as the intermediary between consumers and businesses to automate the ordering and reservation processes.

It is there to store, receive, process and send all the information, not only for all the customers about the business information and their service requests to all the businesses, but also for all the businesses about their customer information and all the services requests made to their businesses. With such centralized Internet server capability about customers, businesses, all the services requests, responses, status, contact and billing information, both the customers and businesses can have access to all of their relevant current and past information anytime, anywhere, and for any reasons.

Although open mobile phone and Internet connected computers are the preferred devices suitable for the use by the customers and the businesses, it is also practical and preferred by some business owners to use other additional means of communications as the receiving devices for simple notification of the arrival of the service requests from the end consumers by multiple means of convenience, such as the additional notifications by multiple traditional mobile devices with instant messaging, the landline phone (via the Automatic voice over IP calls), the automatic fax machine (via Internet Fax by the Internet server), and the network attached printers (via the Internet printing capability built into the Internet ordering and reservation system in the Server). All of these means, including the preferred open platform mobile phones and computers, can be used individually or simultaneously by the businesses to receive the service request and data, and some of them can be used for the responses as well.

This present invention is also related to the integration of the mobile ordering and reservation system with the online ordering and reservation system, in which customers and the business owners can request for, respond to, and access to all information and services in real time, with the same or similar features, functionalities, services, and conveniences of the applications.

The present invention is also related to the integration of the mobile and online ordering and reservation system with other convenient features such as the “mobile notification and reminder system”, which is also part of this invention. The mobile notification and reminder system allows the customers and business owners to either manually or automatically input, update, modify, and save the ordering and reservation event in the calendar of the reminder system, and allow them to set the time for the alarm/alert, and the types of the alarms to be predetermined and set. In such, all the ordering and reservation events, the time and date of the events, can be conveniently viewed, searched, and set for the customers and the businesses.

The present invention is also related to the integration of the mobile and online ordering and reservation system with the local mobile phone's contact information so that they can be cross referenced in the system.

The present invention is also related to the mobile and online ordering and reservation system with the map search tools available on the mobile phones, such as the Google map search.

The present invention is also related to a comprehensive set of new applications and new services developed that have never been proposed, developed, and put into service in the past in the mobile phone or online consumer service industry.

These key features include but are not limited to the following
1) Easy to use intuitive mobile phone based ordering system utilizing the novel “ordering sheet” concept and architecture to greatly help to facilitate the ordering process, much more intuitive and convenient to use in comparison with the use of so called “shopping cart”. With the ordering sheet side by side shown to the consumers on only portion of the current screen and is persistently present and constantly updated during the back and forth ordering process from page to page, this new persistent ordering sheet concept and the service offered is highly demanded by all end consumers. It provides a very clear and intuitive solution to the otherwise complex and less user friendly online ordering process using shopping cart.
2) Mobile ordering and mobile reservation applications and services are seamlessly integrated in the same platform and system to provide users the options and abilities to handle both mobile ordering and mobile reservation at the same time, providing much better user experience. This platform provides one stop solution to both end users and business owners for both mobile and online ordering and reservation.
3) Mobile ordering can be made with the distinction of either for take-out order only or for delivery order, providing both the business owners and the end consumers the options to address their own needs effectively and efficiently.
4) Mobile coupon is made available not only for viewing by the end consumers, but also for placing real mobile ordering directly for items contained inside the coupon. In other words, the end consumer can make mobile ordering not only for the regular items, but also for the special items listed in the coupon directly, combined with the regular mobile ordering. This eliminates the need for the end consumers to bring the hard copy of coupon to the business owners to show the proof of the coupon. The individual items or the conditions of the coupon can now be directly applied to the mobile order request and will be sent over to the business owners instantly.
5) Mobile catering is proposed and implemented by our innovative solution for the first time in the Internet mobile service industry. Normally, the catering service is tedious, time consuming, and error prone, sometimes even quite painful to business owners.
6) This mobile service solution maximizes the benefits of Internet and mobile service, and addresses this very problem occurred in the restaurant industry for many years. This mobile catering service solution now can provide the real time mobile tracking and editing platform so that both the end consumers and the business owners can easily review, select, and modify their options for the catering services. The business owners can change the service options and price at any time. The end users can pick whatever they like and request the business owners for special services to meet their needs. It is an automatic process that can be tracked.
7) Mobile reservation with advanced ordering is another feature that is very innovative in this platform. It provides the customers the ability to make mobile reservation first and at the same time, to place advanced order for the party or for each guest along with the reservation to minimize the waiting at the time of the arrival.

There are online reservation systems that require the business owners to install a dedicated computer with touch screen functions, and also special software. With the installation of these hardware and software, a dedicate restaurant personnel also needs to be trained to support the system and responds back to customers. For tens of thousands of mid or small size restaurants, it is not cost effective and therefore not a good fit to meet their daily need and budget. In addition, this type of systems does not offer online ordering capability to the end consumers. However, the business owners need to have a single integrated online service platform and web portal that can offer all the services together cost effectively, such as web site design, hosting, update, online menu, online ordering, online reservation, online coupon, online catering, and etc.

In addition, the end consumers who have enjoyed the convenience of online service demand even more. For example, some advanced consumers like to not only make online reservation to a specific restaurant, but also like to place advanced orders to the dishes they would like to enjoy when they come to the restaurants so they do not have to wait for too long for their favorite dishes to come, especially for a large party at a holiday time. They really like to be able to place both online reservation and online ordering at the same time to make their party hassle free and more enjoyable.

None of the current online reservation web sites can offer something that is close to what has been described above and what have been requested by both business owners and end consumers. None can offer such a comprehensive one-stop-shop solution to the local business owners.

Our unique architecture and many of our innovative concepts, solutions, implementations and the service offering address exactly what are needed by the local business owners as well as the end consumers. Many of our service offerings and the unique innovations are first of its kinds in the industry.

For example, none of competitive Internet service companies has the ability to send the customer requests directly and instantly to the corresponding business owners using the instant messaging through mobile phones. None has the ability to allow the online orders of individual coupons with regular online orders directly without the need to print out the coupons from the web sites to bring it to the business owners. None of the companies have offered the online catering service so far, which is very challenging not only to the Internet service companies and the business owners, but also to the end consumers.

In this invention, on the restaurant owner side, the owners can choose to use all the tools made available to them, through either computer, or fax machine, or cell phone, or email, or all of above to get the immediate notifications.

On the end consumer side, not all the consumers will have the computer Internet access, nor will they have the computer access the time when they need it. However, a large majority of the consumers will have mobile phones with them most of the time. The mobile service is readily available most of the time from most of the places.

It is much more desirable that the reservation and ordering services to the restaurants industry can be extended to the mobile service platform so that consumers on the go can continue to enjoy the reservation and ordering services by using their cell phones, in particular, by using such phones as the new “Google Phones” or mobile phones based on “Android” open mobile platform, or “iPhone” from “Apple Inc.”

### SUMMARY OF THE INVENTION

This U.S. application is the official filing of the previously filed provisional U.S. patent application, filed on Dec. 29, 2007, entitled “Open Mobile Online Reservation and Ordering System” by Jin Hong and Nicki Zhang, from Saratoga, Calif., USA, and incorporated herein by reference.

The present invention is a comprehensive suite of innovative and unique business, technology and service offerings, as well as the related architectural designs and the detailed platform implementations to support a new suite of services offered to the business owners and the end consumers alike, to make the order and reservation a totally new, enjoyable, memorable and useful daily experience for mobile users and business owners, in particular, in the restaurants industry, based on the mobile platform and the Internet servers. Briefly, a preferred embodiment of the present invention includes a fully integrated ordering, reservation, and event notification system based on the mobile platform.

The current invention consists of two major parts:
A) The novel and unique architecture design for the universal mobile ordering, reservation, event notification system based on the mobile platform and Internet servers. This part will describe how this system is organized and designed in order to achieve the most efficient mobile communications based on the open platform and how the ordering, reservation and event notification actually takes place;
B) The suite of specific innovative services offered to the end consumers and restaurants for the mobile ordering, reservation, and mutual notifications to both parties. This part will describe what types of services will be offered and how it can address the need of the end consumers and business owners so that both will benefit greatly from the use of such service offerings.

Part A: Mobile and Online Ordering, Reservation and Notification System

One of the many key embodiments of this invention is the new platform and system based on the mobile platform in general, and in particular, in this embodiment, on the mobile platform enabled by the “Android” platform adopted by mobile phone makers and service providers.

This architecture design is generally applicable to all the ordering, reservation, and event notifications for a plural of services offered by various industries to the end consumers, such as hotel reservation, ticket reservation, consumer goods ordering, and etc. This design is also specifically designed for and suitable for the application in the restaurant industry, for the mobile based ordering, reservation and notifications.

The following diagram is a brief overview of the processes covering the customer who is making the request, the business owner who is receiving and responding to the request, and the Internet server which is processing and relaying the information between the customer and the business owner in real time, or providing instant information and status changes to either customer or business owner's inquiries.

The system consists of three major portions plus the event notification package.
1) The end consumer uses mobile phones for the ordering of food, reservation of seats, and notification of the timing, addresses, and the status.
The mobile phones work with the Internet server where all the supported business information and services are maintained. Each time the consumer tries to find some interested business for ordering and reservation, the mobile phones will request the corresponding information from the Internet server through the mobile service providers. This is quite different compared with the direct surfing of the Internet using the mobile phones where the data services are enabled. If the mobile has to go to the web site directly and access the information and place order and reservation directly through the web site, then it is a traditional web surfing application, where the special web site needs to be written in the way that it can support the surfing by the mobile phones (using WAP technology) so that it can be shown correctly and conveniently on the traditional mobile phones, even without the need for any specific software. Any phone that can access the Internet shall be able to access the corresponding web site directly, as long as the web site is designed to support the mobile phone.
The “mobile based ordering, reservation and notification system” is totally different concept based on this invention. It provides a suite of applications, in this embodiment, built upon the open “Android” mobile platform, and facilitates the use of the mobile phones to place order and reservation, and gets notification for the events.
It intelligently interacts with the Internet servers and most efficiently organizes, transfers, and manipulates the information between the mobile phones and the Internet servers hosting the aggregation web site with all the business that provide the services. The Internet servers are further relaying the information to the business owners in interactive ways.
2) The online aggregation portal sites that aggregate many of the information for the businesses which are providing the services requested by the end consumers and making sure the services are delivered to the end consumers as requested. This web site and many of the associated web sites for the businesses which have signed up to provide the as requested services to the customers are the indispensable part of the overall system architecture design. These web sites interact directly and dynamically with the mobile phones to provide the necessary information and in addition to relay the customer requests to the business owners so that they know how to respond timely.
3) The business owners have many options in the design of this “mobile based ordering, reservation, and notification system”. They can choose to use the fax, email, the network attached printer, or the computer inside the business (such as restaurant) to receive the customer requests made by customers' mobile phones or by Internet. The business owners do not have to have the “Android” enable mobile phones in order to communicate with the end consumers directly. However, it is one of the embodiments of this invention that the business owners can also have the option to use the powerful “Android” enabled mobile phones that have installed the application software based on this invention. The software is the “mobile based ordering, reservation and notification system”. With this software on the business owner's “Android” enabled mobile phone, it is much more convenient for the business owners to receive, review, and respond to the requests made by the end consumers through their “Android” enabled mobile phones. It is worth noting that the business owners always have the options to use any of the receiving methods mentioned above, or any combination of them, or all of them, including the use of the “Android” enabled open mobile phones.

In the first embodiment of the current invention, the following implementations are used:
a. Generic “event notification and reminder system”: When the current invention is installed on the mobile phone, it will create a first icon on the mobile phone application group which is called the “event notification and reminder system” icon. This icon is generic so that it allows the user to input any event for the notification and reminder prior to the event itself.
It is also automatically linked with the “mobile ordering and reservation system”, so that each time if there is any ordering or reservation event made by the user, and/or confirmed by the corresponding business owners, the event will be automatically saved into the “event notification system” so that the user will be notified and alerted prior to the event, such as the reserved time for going to restaurant or for picking up the food from the restaurants. Although it is automatic, it can also pop for the user to input the required time ahead of the event when the alert is to happen.
The event notification and reminder system provides the functionalities such as: add new events, delete and update existing events, sort out events in sequence of time or event titles, and etc. The event notification and reminder system allows the user to input all key information necessary such as destination, phone number, contact person (which can also be cross-referenced through or by the contact management application package automatically).
The event notification and reminder system is also automatically linked to the “Google” map application for any destination addresses shown in the event notification system.
The event notification and reminder system also allows the user to view the list of events directly on the same mobile screen, with different sorting and ranking priority and sequence, such as the time of the events, the alphabetic sequence of letters in the title of the events, and etc.
The event notification system (reminder) is also linked with the alarm system and allows the user to schedule a proper alarm ahead of the time, in conjunction with the event input. As such, the event notification and reminder system can be customized to fit customer's specific needs.
b. “Mobile Ordering and Reservation System”: An application icon for the “mobile ordering and reservation” will be created on the mobile phones, for example for the one enabled by “Android” open mobile platform, once our application software package “mobile ordering, reservation and notification system” gets installed on the mobile phones.
The icon is the launching pad for the “Mobile Ordering and Reservation System”. When the customer clicks on the icon, it will launch the software package for the ordering and reservation applications.
For reservation to any business, and in this case, to any restaurants that have signed up to take and honor such types of mobile based user requests, the user will have to decide on what they want to find out about the restaurants. For example, the user can specify that what types of restaurants are of interest, such as cuisine types, distance to user's current locations, specific street names or city names, or the previously visited restaurants on this mobile phone. Based on this initial information, the mobile phone will obtain the requested information quickly by contacting the Internet server of the aggregation web sites where all the restaurants signed up so far to provide such services are listed, or hosted. If nothing has been specified, the mobile phone will contact the Internet server and get the information about the most top ranking or alphabetically listed restaurants downloaded into the mobile phone for user to review and select. The user can keep moving down to see more on the restaurant list.
If the user has specified some constraints on the restaurants, such requests will be sent over to the Internet server and the database search by the Internet server will then be conducted ASAP to provide all the necessary information about all the restaurants that fit into the user's constraints. The obtained information is then immediately fed back to the mobile phone. So the mobile phone is fully utilizing the direct real time interaction with the Internet server to provide the information needed by the user.
In this type of mobile to Internet server real time interaction, the mobile phone is not always connected to the crowded Internet all the time. It is only connected to the Internet on as needed basis when the user inquiry needs to be sent to the Internet server and also when the obtained results from the Internet server searching needs to be fed back to the mobile phone. This saves a lot of Internet connection time, and also saves a lot of memory demand for storing large amount of non-necessary information onto the mobile phone if mobile phone is used to surf the Internet for the aggregation web site.
In this mode of operation, the user can select all the constraints to the restaurants before requesting any Internet connection through mobile phone. Also, the user can receive only the information of interest and then can select the restaurant to make the reservation. During this process, the user can take time to input the information needed for the reservation, such as the time, date, number of people, contact information, purpose of the reservation, special notes, and etc. There is no need to be connected to the Internet during this time. This is quite different from using the phone to surf the web which requires the Internet connection all the time. Once the user has all the information ready for the reservation, the user can click on the “submit” button and then send the request to the Internet server. The mobile phone will send all the reservation requests directly to the server at once.
Once the Internet server receives the reservation requests from the user, it will immediately send to the business or the business owners, through a suite of means as selected by the owner. These means can include sending the requests to one, some, or all of the following: the business's fax machine, the email account, the network attached printer, the computer at the restaurant, the regular mobile phone's instant message, the Internet account where the owner or the business manager can login into, or the business' unique mobile phone that has the “Mobile Ordering and Reservation System” installed.
The business owner or manager from the restaurant will receive the user's reservation or ordering requests instantly, through any of the means mentioned above. They can respond back to the user's request as soon as they receive the requests. For example, they can call the customer back if they only receive it through fax or printer, or they can click the right response button if they receive the request through their computer account, or they can respond back with the instant message if they are using the traditional mobile phone and not at the computer at the time of receiving the request (if the customer provides the mobile phone), or they can respond back using their mobile phone equipped with the “mobile ordering and reservation system” directly, which is very convenient and straightforward.
In this last case, the business owner's mobile phone will have all the necessary information from the end customer about the reservation or ordering request, and better yet, it has all the convenient button for the owner to respond back easily by pushing one or two buttons on the mobile phone to either confirm, reject or request for change of the reservation to different time or dates.
When the business owner pushes buttons to respond back to the request, the response will be first set back to the Internet server, and the Internet server will analyze the information and then relay the key message back to the end customer by sending all the relevant information and responses back to the mobile phone of the end customer who has made the reservation or ordering request.
By doing this, the end customer and the business owner are connected directly by their mobile phones, all installed with the “mobile ordering and reservation system”. Their request and response are processed and relayed by the Internet server which hosts the aggregation web portal for all the restaurants that have signed up for providing the services.
The communication between the end customer and the server, as well as the communication between the business owner and the server, are asynchronous, and very short in nature. It takes minimum amount of Internet connection time and mobile phone's internal memories. It provides both the end customers and the business owners the convenience, real time request and response, anywhere and anytime accessibility.
This is the essence of this invention where the Internet connection from mobile phone to server is mostly crowded, and the connection to the server is relatively slow and most of time very time consuming.
Besides, many of the contents on the aggregation sites are not really needed by the end customers or the business owners by the time they need to make ordering or reservation request or need to respond back to the customer request. All they need is the essential information of their interest for the reservation or ordering to take place and get either confirmed or completed. Asynchronous communication between the mobile phone and server is more than enough for this type of ordering and reservation task. The underline assumption of this approach is that the individual user or owner of the mobile phones will spend most of the time to input the information needed for the activities, while the Internet server will spend most of its time to process the received information from both the end customers or the business owners to search for the information needed by them and then send back the corresponding information on as needed basis. So this approach significantly cuts down the link-up time between mobile phones and servers, and eliminates a lot of the unnecessary information to be transmitted between mobile phones and servers.
c. The “Mobile Ordering and Reservation System” on the end customer's mobile phone has the following functionalities:
   i. When the application is lunched, the first screen will show a list of the restaurants on the top, which normally comes from the three different sources: 1) from the aggregation web sites; 2) from the mobile phone itself, where the previously visited or reserved restaurants list is stored and pulled out again when the application is launched; 3) from the contact information in the contact management application package, where the users might have input the favorite restaurants into the contact list already.
   ii. On the first screen, there will be more buttons to choose from: One is the “Next Group” button. When it is pushed, more restaurants will be retrieved from the aggregation web portal. The other is the “Alternative List” button. When it is pushed, more restaurants will be obtained from the three sources: the contact list, the internal memory about the previously visited restaurants, or the more restaurants from the aggregation web portal. In the last case, more selection criteria will be asked: the cuisine types, the city where the restaurants are located, and etc. so that a narrow list can be searched and retrieved from the aggregation web portal and gets downloaded onto the mobile phone for review.
   iii. Once the user has selected one restaurant, by simply clicking on it, all the essential information about the restaurant will show up on one screen, which includes the restaurant name, address, phone, fax, business hours, contact person, cuisine type, price range, parking, brief description about the restaurant, and etc.
   iv. The user can then input all the necessary information, such as the time and date of arrival (utilizing the built-in calendar), number of seats needed, special notes to the business owner, the customer's name, phone, email address, and other contact information (which can be automatically filled in if the owner of the phone is making reservation or ordering), and especially the special notes to the business owner about the purpose of the reservation or the attentions needed. The user can also input the time prior to the reservation time/date to set the alarm on the mobile phone so that the user will receive the alarm as a reminder to the reservation.
   v. The user can edit, modify, delete, or abort any of the process before submitting the request. If the user feels it is ready, then the user can push the button for submitting the reservation or ordering request. And the request will be sent to the business owner instantly.
   vi. The user request will go to the event notification and reminder system automatically. The user can check the reminder system to see all the events queued so far for the upcoming alarms and reminders.
   vii. The user can check all the previous reservation to all the restaurants anytime anywhere by request such information on the mobile phone, the necessary information will be retrieved from the aggregation web portal automatically once the request is made.
   viii. The user can review the restaurant information, and can also view the map around the restaurant using “Google” map automatically for the address showing in the reservation.
   ix. Once the reservation is confirmed by the business owner, an event notification will be sent to the customer's mobile phone through various means, normally through the alarm system or the instant message system. The user will be able to know-that the response is coming back from the business owner already so that he can check. Once confirmed, the reminder and the alarm setting will also be confirmed and updated automatically.

The key part of this invention is the integrated system based on the mobile platform and the Internet server, involving the dynamic and real time interaction of three parties: the end customers (with mobile phones or computers), the Internet servers (with aggregation portal or business sites), and the business owners (with mobile phones or computers, in addition with either Fax or networking printers). The system can support both the mobile based or the online based ordering and reservation process, while coupled closed and directly with the mobile based notification and reminder system. The essence of the invention is to use the Internet server to be the intermediary and the brain to receive, process, and forward the message and information between the end consumers and the business owners.

Part B: The Mobile and Online Ordering and Reservation Service Offerings

The innovative services that can be offered through this open mobile platform based on the current invention is described below in the list but are limited to what is mentioned here:
1) The mobile ordering, reservation and event notification system interacts dynamically and directly in real time with one or more of the designated aggregation web portal sites that target the restaurants and Pizza stores, with categories that automatically distinguish and list the restaurants with respect to the country, state, city, region, zip code, cuisine type, offered online service (such as order, reservation, catering, coupon, take out, delivery and etc.). It can be ranked and rearranged its appearance by the order of cuisine types, English letters, or the city names, or based on the calculated distance near the customers. In such, the mobile order and reservation platform can then have the access to the available restaurants and business owners to make online request through their mobile phones installed with the mobile order and reservation services.
2) The system supports a detailed search engine of its own for the search of any items on the web site, in case of restaurants, the dish names and etc., and comparison of prices offered by different businesses. It loads the menu in a centralized database and therefore each menu item and price is searchable and can be compared with the built-in search engine. These search results are then fed back to the mobile order, reservation and notification system and sent over selectively to the mobile phones and delivered to the end consumers.
3) The system supports online Blog and comments by the end consumers and the feedback & corresponding responses from the business owners, but monitored and mediated by the online service operator. In this way, a simple, fair, and interactive platform and environment is established for both the customers and the business owners to have their voice heard timely. The system provides a platform for end consumers to actively participate into the mobile Blogging session that are fed back to the corresponding web portal sites. This allows the end consumers to be part of the Blogging systems anywhere and anytime, whether through mobile phones or computers.
4) The system supports a fully integrated and consistent online service platform which allows at least a selection of the following key services for each of the business owners:
   a. Mobile or online ordering (either take out or delivery service)
   b. Mobile or online ordering combined with discount or coupon
   c. Mobile or online order using coupon
   d. Interactive mobile or online catering allowing multiple iterations between the consumer and the owners to reach their agreement on the catering service and payment terms
   e. Group based mobile or online order allowing corporate or group members to order food through mobile or online with their own choice from each of the members in the same group but is treated as a single order from business owners' perspective
   f. Mobile or online reservation
   g. Mobile or online reservation with advanced order from the menu
   h. Mobile or online ordering menu with dual language support
   i. Mobile or online ordering menu with individual input notes
   j. Mobile or online service that allows for the self editing and self loading of the mobile or online ordering menus so that the business owners can regularly update their mobile or online order information on the web sites themselves.
With the comprehensive backing of such aggregation web portal sites and Internet servers that are running in the background supporting the online portals, the mobile order and reservation systems become much more efficient, effective and fast, without the need for large amount of memory on the mobile phone and the long downloading and uploading time during the mobile order, reservation and notification process.
5) The system offers a secure and centralized database system which allows both the consumers and the owners to track all the current and past online orders and reservations record with all the details anytime anywhere, and from any computer or Internet enabling devices, whether at home, from work, or on the road. Both the end consumers and the business owners are at the full control of their own information, and the information about the customers' favorite restaurants, or the business owners' loyal customers as well as their contacts. The mobile users will have the full access to their information through such interactions. It avoids the need to surf the aggregation web portal sites directly from the mobile phone and speed up the process considerably.
6) The system offers the users and business owners the interactive responses once the order or reservation has been made through the mobile system. The business owners can notify the customers in real time about receiving of the request, and the status of the request, such as whether the request has been received, processed, rejected, modified, honored, fulfilled, and etc. The end consumers can be notified instantly each time the status has been changed through the mobile devices.
7) The system offers the instant delivery of end consumers' mobile or online order or reservation request to the corresponding business owners through a variety of communication means, using a combination of them pending on the need and the choice of the business owners.
8) The mobile or online request made by the consumers will be automatically transmit to the business owners through the use of instant message and ring tones on the owner's cell phones. The business owners can pre assign one or more mobile phones to be notified of the arrival of the request and the instant message will carry the details of the consumer's mobile or online order or reservation so the owner will not miss any urgent mobile or online request for any reasons.
9) One of the means to deliver the customer's request instantly to the business owners is to send the mobile or the online request directly and automatically to the fax machine in the restaurant through the Internet without any involvement of the Internet service company. There is no manual intervention in between, and no one will be the intermediary between the end consumer and the business owner. The transmission of fax is immediate and no delay of processing of the customer's mobile or online request. In this case, the restaurant floor managers can receive the mobile or online request from the customer and handle it on time without any delay or confusion as to what has been requested by the customers. Our system is flexible and versatile, and can simultaneously send information to the business owner in multiple ways so they can decide on how to handle the customer's mobile or online request accordingly in each case.
10)One of the means to deliver the request instantly to the business owners is to send the customer's mobile or online request directly and automatically to the printer machine attached either directly or through wireless to the computer that is connected to the Internet in the restaurant without any direct manual involvement. The other way is to send the message to the network attached printers without the need for computers. This type of networking attached printers is a powerful tool for sending the message over to the restaurants directly and instantly. The small size of the printers and the printing paper or label is ideal for the restaurant business. Some of the printers such as the POS printers can even print directly to the label that can be used to stick either to the book-keeping record or to the delivery items for the customers.
The use of printers eliminate the need for dedicate phone line for fax, since the printers are usually attached to the computers and therefore share the Internet connection which is usually there already for most of the business owners due to the fast penetration of broadband Internet connections into small business and home business (SOHO), not to say the middle sized or large sized business. It is also more cost effective to have the printers to print out the mobile or online orders and reservations, so that the business owners can use them as the stickers for the corresponding orders or as the note for the reservations. It can be used conveniently for the customer ordered food labeling or delivering services, or combined with the regular book keeping practice in the reservation book.
11)One of the means to deliver the request instantly to the business owners is to send the customer's mobile or online request directly and automatically to the business owners' email address. So the owners can have the access to the emails anywhere anytime and from any computer. The owners can also respond back to the customers directly using emails. This gives the owners the convenience to communicate to the customers, especially the business customers easily. The email notification is only one of the complementary means and is not meant to be the most important and dominant way to send the customer's mobile or online request to the business owners. It is not necessary to be used but normally business owners like to have the options and are willing to receive the emails as well on top of all other major options.
12)One of the means to deliver the customer's mobile or online request instantly to the business owners is to send the mobile or online request through Internet directly and automatically. Since our innovative architecture is based on the centralized server system, the business owners do not need any special Internet devices, do not need any special computer hardware, and do not need any special computer software either.
They can use any computers from anywhere at any time to access their Internet account through Internet. They can review any one of the current mobile and online requests and all of the past mobile and online requests. They can respond to the mobile or online order and reservation in real time to the customers directly in their account by simply clicking on few ready to use buttons, such as acknowledging the receipt of the mobile or online request, updating the mobile and online request status, honoring the request, fulfilling the request, in order to make the status known to the customers.
There are many different statuses that the owner can choose from for both mobile and online ordering/reservation. Some of the statuses can be one of the following (but not limited to): “received”, “confirmed”, “rejected”, “fulfilled”, “to be further determined”, “no show”, “show up”, “show up with less people as requested”, “food taken”, “food delivered”, and etc. The end consumers can review the statuses on their mobile phone or directly online as well anytime, anywhere, and from any computer connected to the Internet.
On one hand, the business owners will be able to review and respond to all the mobile and online order and reservation requests from all the customers who have made requests to their restaurants. In this way, the owner can have a rich database of the customers, the customers' contact information, locations, favorite dishes, time of the parties, and etc.
On the other hand, the end consumer can review all the mobile and online orders and reservations the user has made so far to all the restaurants up to now, and with all the information about the restaurants' information, the favorite dishes, and the time and size of the past parties and etc. The consumer can recommend to the friends or co-workers.
13) The key part of the instant notification to the business owners without the intermediary manual intervention is the use of a combination of some of the means mentioned above simultaneously.
For example, the most popular choice from many business owners is the use of most means at the same time. The customer's mobile or online request will be sent to several mobile phones through instant message (owner's cell phone, floor manager's cell phone, the waitress's cell phone) automatically from the aggregation web site or our customers' own website once the mobile or online order or reservation request has been submitted by the end consumer.
It will also be sent to either the fax machine located at the front desk of the restaurants or the printer attached with the computer at the front desk (if it is the network attached standalone printer, it is even better).
Of course, at the same time, it will always be sent to the owners' email, and to the owner's Internet account registered with the aggregation service web site.
Of course, in addition, it is best if the business owner uses the mobile phone or PDA equipped with the “Android” open mobile platform and also installed the “mobile ordering, reservation and notification system” just like the end consumer has, then it would be much better for the owners to receive and respond to the customer's mobile request. The business owner's mobile phone equipped with this innovative system should be able to receive instantly, review and respond to all the orders or reservations in real time, without the need for either the access to computers or the need for fax machine at the restaurants. The mobile phone itself will provide all the functions he or she needs anywhere and anytime.
So the business owner would know instantly that a mobile or online request has come due to either the cell phone rings associated with the arrival of instant message, the arrival of fax, the printout from the printer, email notification from the computer, the screen notification from the computer, or the cell phone call notification. They can choose how to respond to the customers based on the nature of the mobile or online requests (ordering, reservation, catering and etc) by either using cell phone calls, sending response email, or login into their Internet account to respond directly, or send back instant message to the end consumer's cell phone, or through the “Mobile Ordering, Reservation and Notification System” to notify the customer on their cell phones which are also equipped with the open mobile platform based on “Andriod” platform, or simply do not respond if there is no need, and then either directly deliver the food to customers, or wait for the customers to come over for pick up, or prepare for the customers to come to have the party, and etc.
14) “Mobile Phone or Online Based Ordering Sheet” for convenience
One of the most important features of our solutions is the innovative and intuitive “mobile or online based ordering sheet” feature implemented on our mobile phone system and also on our web site. The feature addresses an important issue in most of the mobile and online service business that is related to the use of “shopping cart”.
The “shopping cart” is a modular software package embodied in several different ways and developed by many Internet service companies to help online commerce companies to facilitate the online shopping, in the way very similar to the real shopping cart used in the shopping mall in people's daily life.
The online customers will pick any items they would like to have and then place them into the online “shopping cart” and then move on to the different places or pages on the online commerce's web site while they continue to shop for what they need from pages to pages, from categories to categories, from areas to areas.
Each time when the new item is placed inside the “shopping cart”, it is hidden inside the cart and cannot be viewed directly unless the customers specifically open the “shopping cart” again to review all the items already inside the cart.
This is quite inconvenient for customers, especially when they try to go back and forth to check the items to make sure they do not miss or over order anything. The web site will not be able to remember which one has been ordered and placed inside the cart and which one has not been ordered at all. The customers have to review the items inside the cart every time to see what is inside and how much has already been ordered, or remember whether certain items have been ordered.
This becomes even more inconvenient for mobile phone users since the mobile phones have small screen, and relatively low speed to Internet connections. Coming back and forth to review the content inside the shopping cart and to check items being ordered, would be a huge task that will be a slow, tedious, and annoying experience for most of the customers. In order to overcome the limitation and inconvenience of “shopping cart”, a very innovative and intuitive approach and solution to the mobile and online ordering process has been proposed and implemented. This is the “mobile and online ordering sheet” solution.
In this solution, a “mobile and online ordering sheet” is created automatically, similar to the order sheet a waitress uses to write down the dishes the customer wants in the real restaurant when the customer tries to order the dishes while sitting besides the table in the restaurant.
The “mobile and online ordering sheet” is persistently presented on the right hand of the ordering screen on the customer's computer no matter how the customer will go back and forth from page to page, and from category to category, to review the menu items, and to select the items to be ordered. On the left hand side, the menu items changes every time the customer goes from one page to another to review the menu.
Every time the customer chooses some items to order, the items of the choice and the number of items ordered will be highlighted in the menu sheet and stay current and persistent in the menu sheet. It will not be changed even if the customer goes to different page or category for more orderings, it will stay highlighted without being refreshed. This allows the customer to go back and forth between pages to make the choice without losing the previous choice for other items. When updating the order sheet, the items being chosen will be copied to the “mobile and online ordering sheet” with all the necessary information to make mobile or online ordering.
Again, the “mobile and online ordering sheet” will stay persistent with all the items updated by the customer, and will not lose any information no matter how the customer will go back and forth between pages and categories. So the customer can always see what have been placed into the ordering sheet, how much they cost, and etc.
When the customer finishes the selection, the customer can choose the service options, such as “take out” or “delivery”, and then select the time and addresses for the service, and update the “mobile and online ordering sheet”. The information will again be copied onto “mobile and online ordering sheet” and stay persistently viewable at all time anywhere during the ordering process.
Once the customer finishes all the selection and provides all the necessary information, the customer can start to submit the mobile and online order request. At this time, all the information inside the “mobile and online ordering sheet” will be presented to the customer again, with the options again to change anything to the selection, such as “deleting” any of the items ordered, or “modifying” any of the numbers of the items to be ordered. At the same time, the system allows for the customer to write additional notes in addition to the ordering to specify any special needs or requests from the customer for the mobile and online ordering, such as to make certain food “more” or “less spicy”, and etc.
If everything is ok after the final review, then the customer can finally submit the mobile or the online request to the corresponding business. Then the mobile or online request will be instantly sent to the corresponding business owner directly and automatically, through mobile phone notification system, or the mobile phone's instant message, fax transmission, email, Internet account, or sometimes, or the network attached printers, or all at the same time, simultaneously.
The “mobile and online ordering sheet” is one of the most distinct features embedded and supported inside our unique and highly scalable system architecture and most innovative platform implementation, and is most flexible, persistent, versatile, convenient and intuitive to use for the end consumers.
15)Coupon is mostly distributed through massive distribution channel to the hands of consumers, either through flyers, coupon books, or nowadays though Internet web site. For restaurants, it is much more important to attract the loyal customers to come back regularly. Therefore it is very critical to be able to reach out to the customers with new coupons all the time. Mostly, the coupons are distributed through the traditional means as any other types of coupons.
With the use of mobile and online ordering, more and more people like to use Internet to order food directly without the hassle to call the restaurant and get a busy signal or to wait on the phone for 5˜10 minutes, or to talk over the phone loudly to make sure the restaurant employee understands the customer's spoken English and know what the customer is asking for.
Mobile and online order provides a lot of convenience for customers so they can even order the food when the restaurants are closed for the day. However, if the customer wants to use the coupon offered by the restaurant separately or in combination with the mobile and online order, normally the customer has to bring the hard copy of the coupon from the restaurant or print a copy from the Internet and then presents to the restaurant physically. This is still a traditional and very old style of using coupon, and is not convenient to the customer at all, while the customer is already using mobile phone or using the Internet to place online order.
It is in this invention that a new way of using coupon is proposed and implemented in our web portal for the “mobile order or online order with coupon” service. We design our system architecture in the fully integrated way so that coupon is also part of orderable items inside the mobile order and online order system. All the coupons are listed as separate orderable items, and each coupon can be ordered separately.
When the requested coupon is clicked upon for mobile ordering or online ordering, the content inside the coupon will be managed in the way that the customer can actually determine the price of the coupon (absolute price, or the relative discount, or discount with conditions against the regular order amount, and etc), and the content of the coupon.
For example, the content of the coupon can be as simple as one statement as below: “offer discount up to 10% for order amount up to $30, and 20% for order amount up to $80.” In this case, the mobile ordering or the online ordering system has to check to see if the customer has already ordered some regular food into the “mobile and online ordering sheet”. If not, the coupon cannot be used. If the regular order has been selected, then the system will check to see the total amount of the regular order is in the range of the offered coupon. If it is within the valid range, the discount level will be applied to the regular order, and the total order price will be determined. And finally the mobile order or the online order with the intelligent information of the corresponding coupon will be sent to the restaurant instantly, so the business owner will know that the right coupon has been applied to the order and they will honor the “mobile or online order with coupon” without asking for the presentation of the hard copy of the coupon itself.
Another example is when the content is quite complex, such as the following: “offer a family deal with three any types of large Pizza, each with 2 different toppings at customer choice for a total of $30 only, with three additional soft drinks of any kind free”. In this case, once the coupon is clicked upon and selected by the mobile ordering or online ordering customers, the system will have to present the customers with all the available types of large Pizza asking the customers to choose three types of different large Pizza he/she likes first. For each of the large Pizza, the system shall then have to present the customer with all the available toppings the customer can choose from for the particular Pizza. The customer can only choose two toppings, not one, not three. In the end, the system will also present all the available soft drinks for the customer to choose three soft drinks from them.
Once it is done, the “mobile order or online order with coupon” will be combined with other regular mobile or online orders, all onto the “mobile and online ordering sheet” and then sent to the restaurant instantly.
In summary, through the illustration of the above example, “mobile or online order with coupon” as a feature has been disclosed and is considered to be one of the most innovative features in our architecture design and system platform implementations. To the best of our knowledge, it has never been proposed and implemented and offered to the mobile or the Internet customers in the past.
16)Interactive Mobile and Online catering
One of the most tedious and time consuming tasks in restaurant business is the catering process. Each time a customer calls to ask for catering service, it will take a lot of time to interact with the customer to decide what exactly is required in order to support the catering events.
Most of the time, the customer will even have to drop by the restaurant several times to sit down with the business owner to discuss in great details on how to organize the catering events. After that there will still be a lot of back and forth phone calls to make modifications and to make sure the catering menus.
Nevertheless, the catering market is one of the largest markets in restaurant business and therefore normally the business owners are willing to put up a huge amount of personal time to see through all the details for any catering events.
In order to address such a huge market and eliminate the tedious work, we have a very innovative and unique approach to solve this problem. We proposed a new architecture in our system design and have a platform implementations to support “mobile and online catering” feature.
“Mobile and online catering” is a platform that allows the customer and the business owners to discuss and decide on the detailed of the catering events through the mobile phone and Internet. It is part of the integrated “mobile and online ordering” process, except now the ordering menu is not the regular food menu for mobile and online order. Rather it is the special catering menu that will be used as the initial starting point for the catering event discussion.
The customer will review the available standard catering menu either through mobile phone or online, and select what is more suitable for the catering events, and then write some notes and send to the business owner. Normally, there will be a lot of additional request attached to the first online catering request. These additional requests will be received by the business owner instantly. He/she can decide if there is a need to modify the online catering menu, to add items, to change price, and etc, based on the input from the customer. Then the customer can review the online catering selections he/she has made so far, and do the necessary changes or modifications.
This process can keep going anytime, anywhere, from any computer, by both the customer and the business owner. All the selections are made available through mobile or online process with a simple click of mouse or cursor. Both of the end consumers and the business owners do not need to write down anything or calculate anything. The entire “mobile and online catering” process is interactive and can be consistently updated. In addition, more than two persons can be involved. For example, from customer side, anybody from the entire catering party can review the catering menu and the ordered food, while other people from the restaurant sides can also review the catering events, modify or prepare for the events using “online catering” information.
In addition, all the catering events are stored in the central database, and both the customer and the business owner can check out all the catering events information anytime in the future. This type of information will become an invaluable asset of the customer or the business owner.
17)Online reservation with advanced order of dishes
There are several online reservation sites in the market place, but none of them has used the wireless instant message to notify the customers or the business owners, which is one of our distinct and innovative features in our system design.
However, to meet the ever increasing demand of the more advanced customers, there is an even better way to help the well organized customers to arrange for business dinners, celebration or wedding parties, anniversary events, family or friend get together.
This is to allow for the advanced planning for the types of dishes to be served for the entire party or for the individual guest at the restaurant after the arrival of the guests. This can be achieved during the online reservation process, when the customer submits the online request indicating what type of party it will be and what will be the special requirement he/she would like to have for the party from the restaurant. At the same time, the customer shall be able to review the online order menu carefully, and decide on which dishes should be ordered in advance at the time of reservation. So the customer can make the reservation and at the same time make the order for the food to be served on the date of arrival.
In this way, the customer will save a lot of valuable time by avoiding waiting in the restaurants for a large party, and also will make sure the restaurant have the right dishes for the party in case the restaurant runs out of the necessary food for some of the favorite dishes.
In addition, our solution has also the unique feature to assign each menu item with a unique customer note, so that each dish or menu item can be associated with one special note or a special person's name. (Please note this is one of the very innovative solutions in our system which will be addressed in the next session of this patent application. It is so called “online ordering with individual note and label on each menu item” feature)
This feature is particularly important when making online reservation with advanced online order. Each order can be assigned with one or more person's names, so that it will be very easy for the restaurant and the party organizer to manage the dishes and to make sure each guest gets what they want in advance without any confusion. Each guest can even go online any time prior to the arrival time to review the choice of his/her food and make his/her own selection and modification. Please note this feature is also one of the most innovative solutions in our system, which allows each of the party members to be able to login into the same online reservation or online ordering record and do the modification or selection on his/her part. This is so called “group online reservation or group online ordering” feature that will be addressed in the next few sessions as well.
This “online reservation with advanced ordering” feature offers a great deal of convenience for online customers, and also for restaurant owners, who will have more and more loyal customers.
So far, in the online service industry, no company has offered such service yet in the restaurant business. We are the first to propose such a business model and implement in such a fully integrated online order and online reservation system.
If offers our customers the most compelling advantage in using online reservation with advanced order, capability.
18)Online order using menu supporting multiple languages
Restaurant business is very different and unique compared with other businesses. First of all, there are all kinds of restaurants everywhere that serve different types of cuisines and foods. All of them serve the entire communities but each with very different and particular focuses to specific groups of population, and very often to specific ethic groups. Within those ethic groups, there will still be a large variation in education and income levels. Some of them can only read menus in their own ethic language, and some of them may prefer to use menus in their own mother languages regardless how fluent their English may be.
When coming into restaurants, some food and dishes can only be best expressed or described in their native language in order to precisely convey the message to the ethic native speakers. That is why many restaurants actually prepare two different menus, one for English readers, and the other for the native language speaker. Some restaurants may combine these two menus together into one menu that contains both languages: English and the other native language.
Because of this very reason, and also in order to address to the entire population, and to help the restaurants to attract more customers, an innovative solution has been first proposed and implemented in our mobile and online order and reservation system, which supports dual languages inside the mobile and online order menu simultaneously. One is English, and the other is the native language the restaurant may like to use to attract the specific ethic group in the community. For each of the restaurant, the native language can be chosen to be different based on the need from the restaurant.
In this way, our solution and business model has addressed a very common and unique problem throughout the restaurant industry, which no company and no Internet service product has ever addressed so far. This is very unique in the way that only the menu portion supports two different languages so that both the English speaker and the native speaker can recognize the same dish but in a totally different sense of comprehension. This helps tremendously both the customers and the restaurant owner. All of them simply love this very special feature.
19)Mobile and online order using menu supporting individual note and label input for each dish
For different restaurants, each dish might have a different flavor. For example, in Thai restaurant, many of the dishes can be customer made to suit the taste of the individuals. Some may like the dish to be very spicy, some may like it to be spicy, some may like it to be mild and some may like it to be non-spicy at all, such as for kids. Therefore there are a great deal of needs to be-able to order each dish with different notes from the mobile menu and online menu so that the restaurant can understand the special needs or taste of each customer, and therefore can better serve their customers and retain the customers' loyalty.
In addition, as mentioned above in the “mobile or online reservation with advanced order” feature, each dish can be assigned with a different people's name so that the restaurant would know who this dish will be for when the guests come to the restaurant.
Therefore, in order to address the real needs from customers and from the restaurants, a new feature in our architecture has been proposed and implemented to serve our customers better. This is the feature called “mobile and online order using menu supporting individual note and label input for each dish”. Each of the notes can be the name of the person this dish is for, or the way the dish should be made in order to suit for the customer's taste, or the combination of both, or even any other note the customer would like to add. For example, the customer can ask the restaurant to prepare certain dishes much earlier before the arrival of the group, or ask the restaurant to not to start to prepare this dish until their arrival because the customer wants to have the hot taste of the dish when it is just cooked when he/she starts to sit down in the restaurant.
No matter what the customer wants, the feature provides all the flexibility and convenience to the end consumers and the restaurant owners alike. So far, no company or no web site has ever proposed and implemented this idea. This is to our best knowledge the first of such implementation.
20)Group or corporate mobile and online reservation and order
In the Internet and mobile age, more and more people are using Internet and mobile phones. All the employees within a corporation are using Internet and majority of them also uses mobile phones. Most of people's family members and friends are also using Internet and mobile phones as well.
It is natural that when the a group of people from the same company want to get their lunch ordered, each likes to have their own choice of food, but would like all the food to be delivered at the same time to the same company location for a group lunch or dinner, or even business meetings. Similarly, a group of friends may like to have different food from the same restaurant delivered to the same address, which may be one of the person's home address, or one of the company locations.
They are many other occasions that a group of people would like to make either mobile or online ordering from the same restaurant and get the food delivered to the same address at the same time. Basically, all the mobile and online orders will be treated as one “group order” or one “corporate order”. The common part of this order is that everybody in the same group can either use their own mobile phones or to login into the same web site using the different name and password, but can identify themselves as one of the same group, and order different food for the same order number. This can be done by different people from the same group individually using their own user ID and password, or can be done by the group organizer or the corporate secretary, receptionist or administrative assistant on behave of all the individuals in the group to order different food for them individually, but get all the food delivered on the same order request.
The group or the corporation can also establish long term relationship with the mobile order or online order service company who is providing the mobile and online order and reservation service, so that the corporate needs only to deal with the mobile and the online service company for the payment, while the mobile and the online service company will pay the restaurant accordingly. The closing of these payments may be on different terms. For example, the mobile and online order service company may pay the restaurants instantly using their own credit cards, and then get paid by the corporation later on monthly or quarterly basis. Or the group or the corporation may simply pay the restaurant directly, and the mobile and the online service company will not be involved with the payment between the end consumer and the business owner. There are different operation modes that form the foundation of a new set of mobile and online service business model. Regardless, the “group and corporate mobile and online order and reservation” system is a novel, unique, very handy and useful service for Internet and mobile population.
21)Mobile and online order and reservation with statistical analysis and billing
One of the issues for mobile and online order and reservation system is to keep tracking on the past orders and reservations that have been rightly fulfilled, and to keep tracking the activities of customers, and about the statistics of the return customers vs. new customers, and etc.
Our system has utilized a centralized database which allows both the end consumers and business owners to utilize the exact same database to extract all the information that is relevant to them only. Since all the detailed records have been kept so the customers or owners can either download through the mobile phones or login in to get all the information they need. The owner will have all the information for the past orders, and reservation, and can look into the information through various categories, such as the most ordered dishes, the average order amount, the most frequently ordering time, how often the coupon is used associated with the order, what types of coupons have been used most frequently, the customer contact information, locations, how many loyal or frequent return customers, how often the order is for pick up or for delivery. Similar information can be obtained to mobile and online reservation records, such as: average number of seats reserved, time of the reservation, time of the arrivals, types of customers, their contact and locations, and etc.
Our system is unique in the way that we offer the customers and the business the ownership to their information and their data. We also offer them the analysis tool that will help them to surf through the data and draw their own conclusions to suit their own needs. Monthly or quarterly mobile or online bill statement is only one of the many ways to offer our customers the convenience and the power of our fully integrated comprehensive, automatic and yet interactive mobile and online order and reservation system.
22)Mobile and online self loadable, editable, and orderable menu service
In the past, most of the web sites and the mobile access devices offer some menu services, such as putting the restaurants' menu on the restaurants' web site, or on the Internet service aggregation web sites, so customer can go to the web sites to look for menu, check on the price, and see if certain restaurants have the dishes that they like.
Most of these web sites only put either a PDF file on the website so customer can read and print, or they put html page on the web site so customer can surf around. There is normally not much to be done with the menu on the web sites. If it is a PDF file, it is not easily searchable for the dishes inside the menu, not to say the price of each dish. If it is a HTML file, it is difficult for the owners to do anything about it if they like to change the menu themselves, or upload the new menu all together.
Restaurant business is a very competitive business, and is changing on seasonable basis. For example, the owner has to make sure the dish he/she is serving is to the taste of the customers, otherwise he/she has to change it. Also, on all major holidays and periods with major events happening, the restaurants will most likely modify some of the dishes, add some specials and coupons, and adjust prices, and etc. It will be best if the restaurant owners can handle these changes themselves if they are provided with the easy way to update their own information on the menu. In order to do that, our system has started to handle the menu in a totally different and novel way compared with other web sites.
Our business model is that with certain and proper business agreement with the restaurant owners, we will provide them with the total solution that allows them to do just that. We treat each menu as a self loadable file using XML technology. XML is a human readable computer language that is easy to understand and easy to track. Each menu will be directly input into a XML file that has dozen of tags to show the information in the menu, such as dish's native name in the native language, the dish's English name, the additional explanation note to each dish, the price, and any other information that is needed for that dish. Then this file will be automatically loaded into the database system utilizing our own special XML file loading capability so that it will be shown up in our system as the orderable menu for customer online order.
At the same time, this menu become also fully searchable for each of the menu item parameters, such as the native name, the English name, the price, the note, and etc. We also develop our own search engine to search and compare items within the database. Therefore, the search engine can search for all the information related to the restaurant, and can also compare the different offerings from different restaurants, within the same regions or across the country. For example, the search engine can search for all the restaurants which offer a famous Chinese dish called “Peking Duck” and then automatically compare the offerings, and prices from each restaurant within certain areas. Our search engine can search items with many different categorized criteria in such it limits the unrelated information to be searched and displayed. In such our search should be much faster and very accurate to the need to the customers.
Once the menu is loaded into the system through the XML file, the business owner will then have the freedom to modify menu's contents on their own. Our system architecture is designed in such that we will provide an easily accessible and very intuitive web interface for the business owner only, to allow them to modify and change any of the menu items online.
At the same time, since the menu is itemized and stored into central database, once the menu is modified and automatically loaded into the system by either the company, or the business owner, each item will be also automatically orderable through our mobile and online ordering system.
Therefore, this system is the most automatic, most convenient and most straightforward one that can be used by a large population of the restaurant owners themselves. This system is most scalable and covers the broadest applications from the self editing and self loading of the menus, automatic loading into online ordering system, self update into the online system for end customers to use, to the ability to be fully searched throughout the database detailed to each restaurant, location, its web site, each of its dish, its specialty, its price, and etc.
The mobile ordering, reservation and notification system interacts dynamically and directly with the aggregation web portal sites to download the menu or to upload some of the updates so that the mobile phones can be the powerful tools for the business owners to dynamically update their menus on the web sites.
23)Mobile access and online service aggregation web site with customized web portal hosting capability enabling mobile and online order and reservation service for each restaurant owner
In the Internet and mobile age, tens of thousands of businesses have their own web sites and their own mobile phones for the marketing of their business. But at the same time, there are still millions of businesses which do not have the web sites of their own. For example, in US, there are more than one million of restaurants, and most of them still do not have their own web sites.
The reasons are many: some restaurant owners do not know much about Internet, or do not know how to utilize Internet for the marketing of their businesses, or they do not want to spend money to build and maintain the web sites. In addition, most of web sites, once designed and put into operation in the Internet, it is hard for the restaurant owner to go back to original designer or the company that has designed the web site, to update the menu and price information. This is mostly due to the high cost of maintaining and updating these restaurant web sites. Few companies can afford to keep doing so without charging a lot to the restaurant owner.
A specially designed web site specifically for a restaurant can easily cost the owner several thousands and even more than ten thousands of dollars, which the owner may not like to pay up front, for a pure static web site without any other functionalities such as online ordering, online reservation, online coupon, and without the opportunity to update the web site with new information regularly.
In order to address these issues, and give the owner the opportunities to update the menu items and prices on their own whenever they feel necessary, and also to cut down the cost of the upfront web site designs, we have come out with an innovative approach.
We design a restaurant web site template that supports all the desired features such as mobile and online ordering, mobile and online reservation, mobile and online coupon, mobile and online status check, mobile and online reservation with advanced ordering, mobile and online catering, and etc, suitable for both mobile based or online based consumer requests. For each restaurant, the web site will be automatically generated by the template, with the customized logos and other information. These special and restaurant specific information will be defined by a comprehensive XML file, which can be automatically loaded into the system to modify the common template and therefore generate a specific web site for the specific restaurant automatically.
In addition, these XML common files are also built into the system through an owner accessible use interface on our web site. When the owner logins into the system and starts to modify the menu and the price, the modification and edit he/she makes will be automatically translated into the specific XML file associated with the restaurant. The XML file will then automatically loaded into the system to update the associated restaurant web site, including the automatic update on the online order menus and prices as well. The business owners can also use their mobile phones that are enabled with “Android” platform and the “mobile ordering, reservation and notification system” to do the timely and necessary updates to their own web portals within our aggregation web sites.
With these functionalities and features, we have really achieved a truly automatic and interactive comprehensive system as an aggregation web portal that can automatically generate and host a large number of restaurant web sites, all with the complete sets of mobile and online service features fully available to the restaurant owners so that they can choose any mobile and online services they like to be present on their web sites. This is a truly revolutionary approach to enable a very cost effective and automatic process that can help millions of small and middle size restaurants to get online and also get their customers to use either Internet or mobile phones to place service requests, with all the most powerful Internet and mobile service tools and options at their choice. This will significantly advance the use of Internet and mobile phones in the restaurant industry and help millions of users to enjoy the freedom and convenience of mobile and online services.

In summary, an advantage of the present invention is that it is a fully integrated and comprehensive mobile and online order and reservation system that have many innovations and have implemented a dozen of leading mobile and online service features, such as “mobile and online order sheet”, “mobile and online order with coupon”, “mobile and online reservation with advanced order”, “mobile and online order with dual languages”, “mobile and online order with individual notes”, “group and corporate mobile and online order”, “mobile and online service with periodic statistics report including billing”, “mobile and online catering”, “mobile and online hosting with automatic web site generation”, “mobile and online order menu self loading and self editing”, “mobile and online order with instant messaging notification”, “mobile and online order with automatic fax”, “mobile and online order with automatic Internet printing”, “mobile and online order and reservation with automatic mobile and online tracking system”, “mobile and online order and reservation automatic and interactive response system”, and etc.

These features are highly demanded both by the Internet/mobile users and by the business owners such as the restaurant owners. These features highlight the key benefits of Internet and mobile networks: freedom, on-the-go, convenient, instant, interactive, intuitive, traceable, searchable, statistically viable and useful, private, hassle free, intelligent, and most of all, free to the end consumers, and very low cost to the business owners.

These and other objectives and advantages of the present invention will no doubt become obvious to those of ordinary skill in the art after having read the above and some of the examples in the following as the best mode of operations. The key part of this invention is the centralized automatic online service platform utilizing Internet, computer, mobile device, Internet fax, and the Internet attached printers to link the end consumers with business owners through the automatic process without intermediary intervention in between.

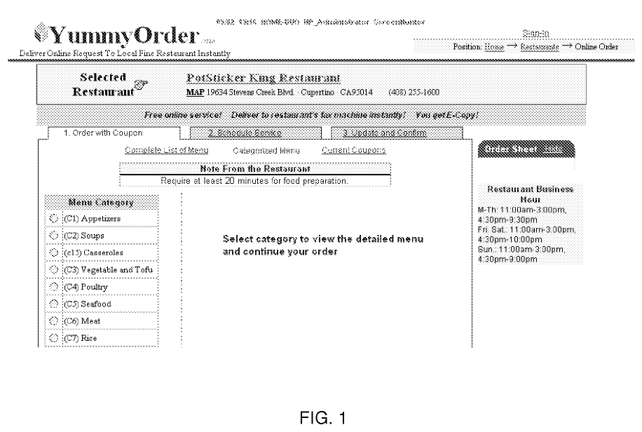

FIG. 1 is a screen capture to show one of the examples of the online order process. This is used only as a reference to demonstrate one of the implementations. All the implementations are subject to changes without notice to any customers or business owners, but the inside architecture design and algorithm will stay very much the same based on the architecture outline in previous session. This is only one of the many possible interface embodiments of the current inventions.

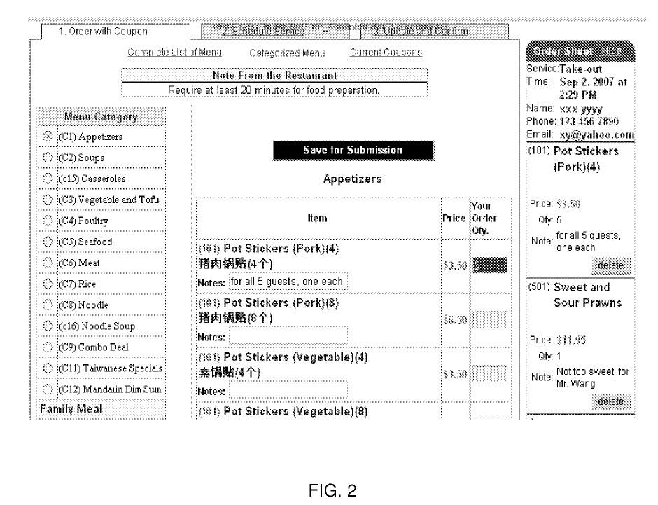

FIG. 2 is a block diagram showing one of the screen shot for the online order feature with “online ordering sheet” on the right hand side, the “online menu with dual languages (in this case, Chinese & English)”, the “online note for each dish” feature and etc. This is only for illustration purpose since there are many variants in how to implement the features. This is only one of the preferred embodiments of our innovations.

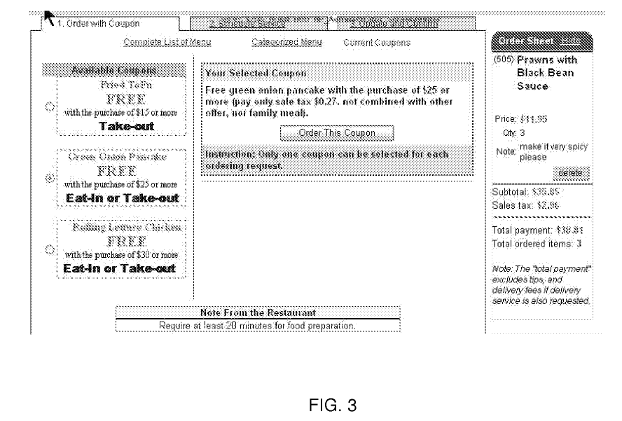

FIG. 3 is one of the preferred embodiments of the present invention implementing “online order with coupon”.

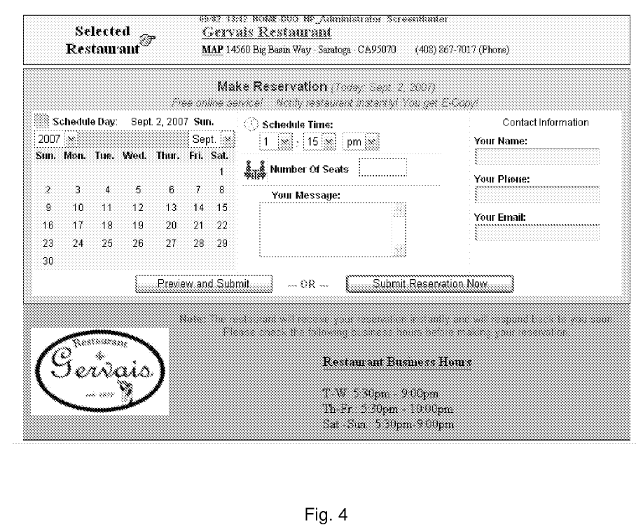

FIG. 4 is one of the embodiments for online reservation.

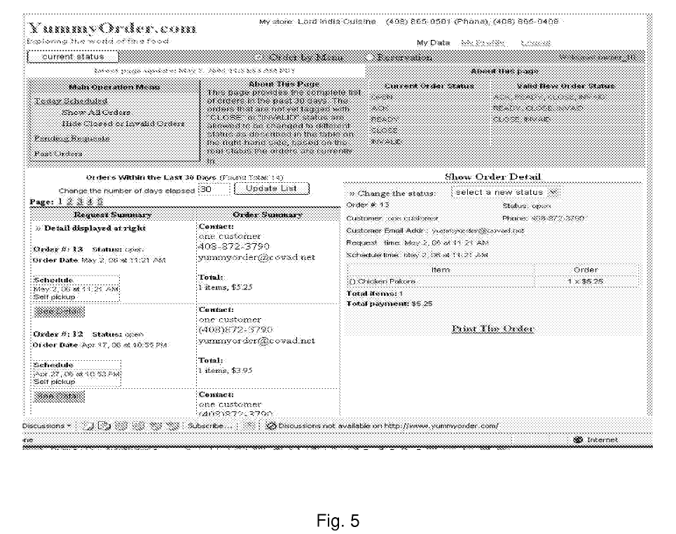

FIG. 5 is one of the embodiments for business owner side of management for online reservation and online ordering. The owner can see all the current, pending, past, and total orders or reservations, and he/she can decide on how to respond to each request timely using Internet. There are many other ways to respond to customers. Here is only one of the options using Internet login in account set up by the online service operator.

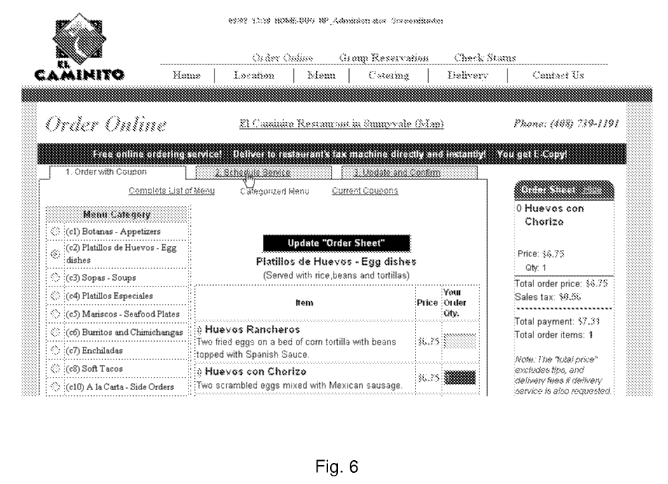

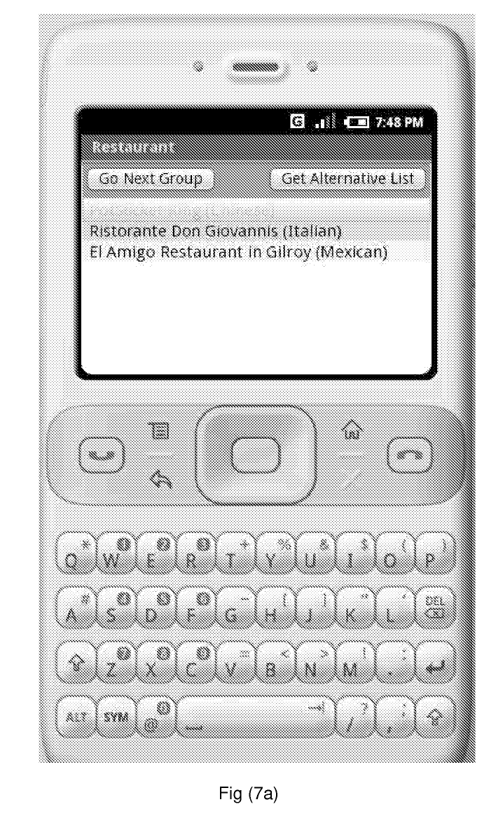

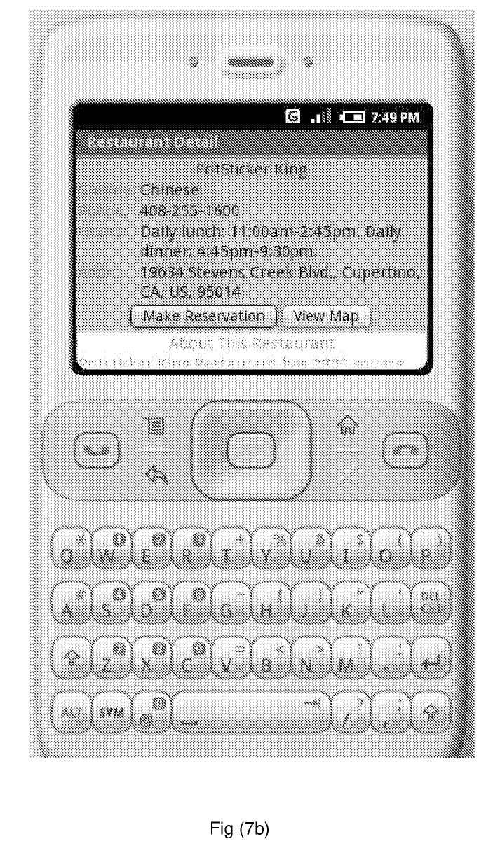

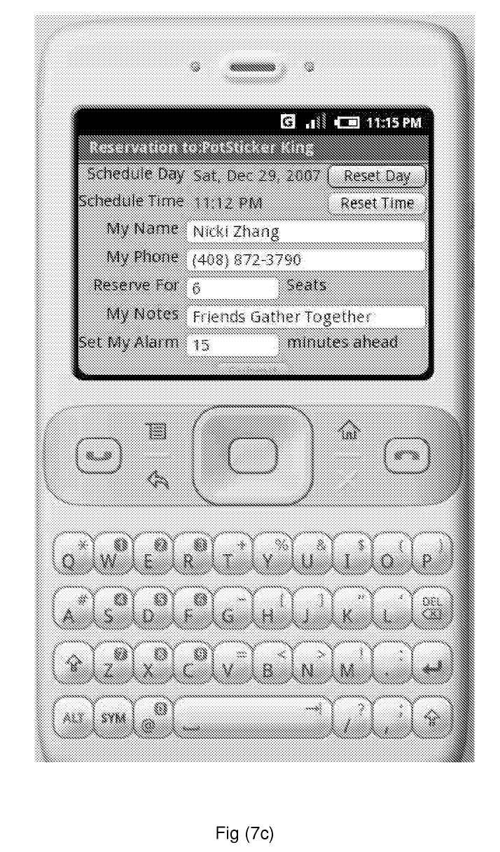

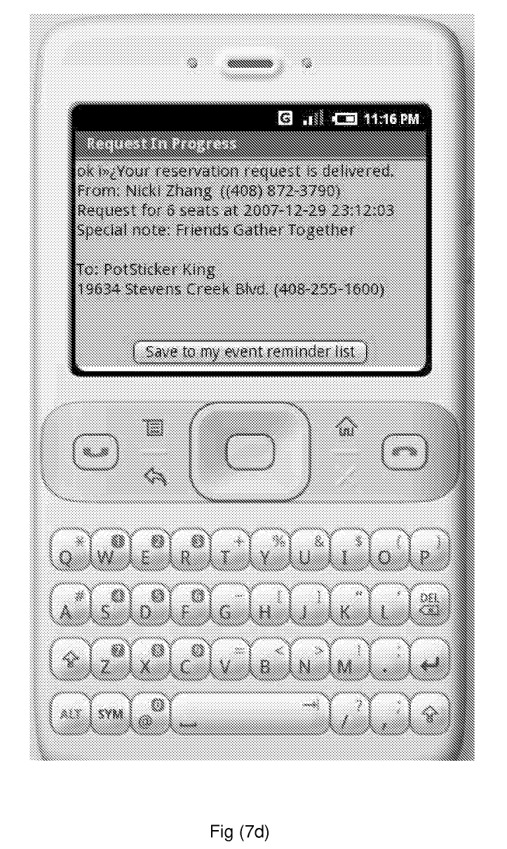

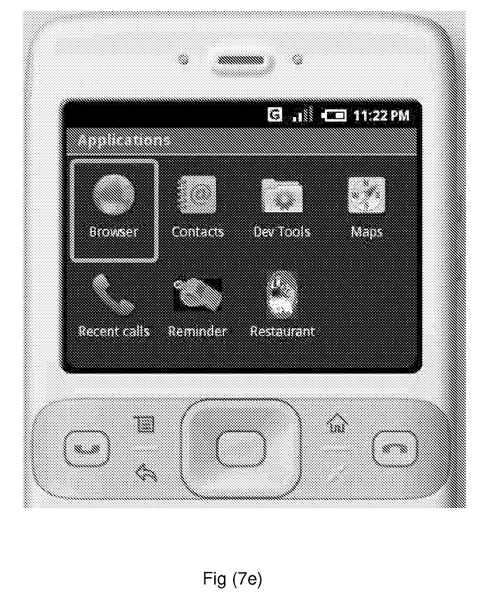

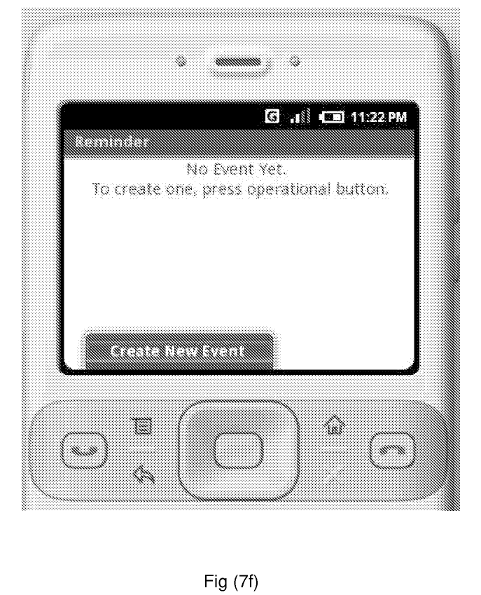

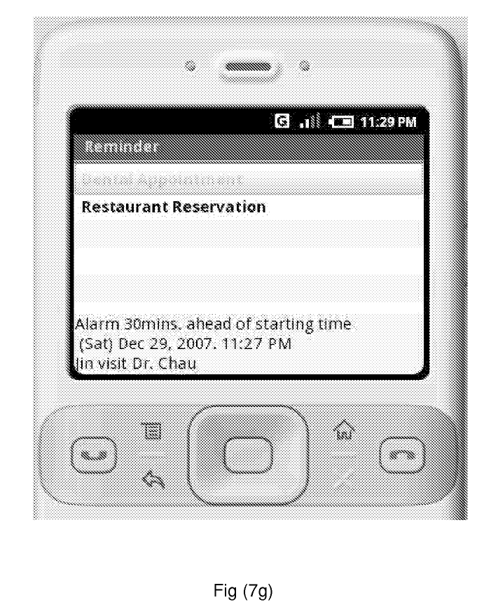

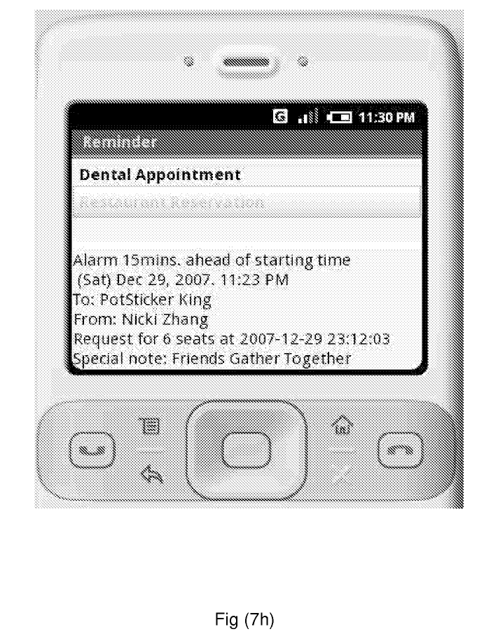

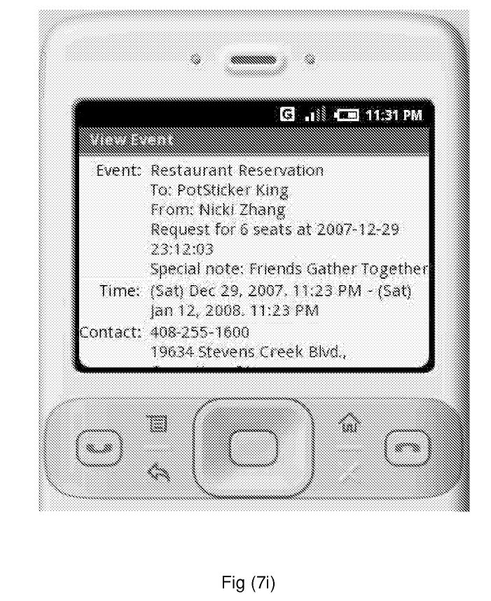

FIG. 6 is one of the embodiments for customized online order and reservation on the customer's own web site. It is automatically generated for the customer web site, and can exhibit all the features on our web site.

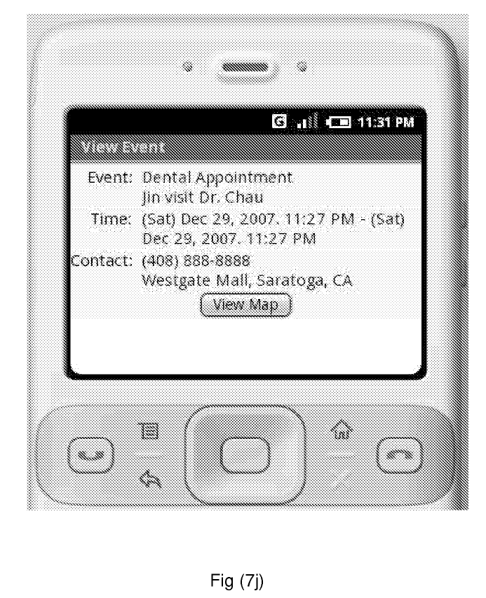

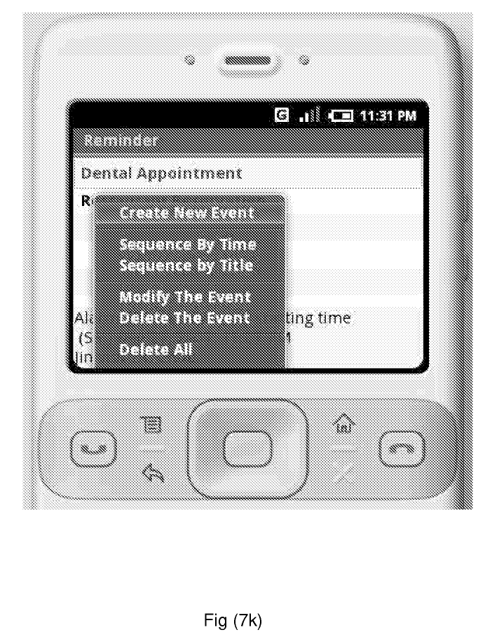

FIG. 7 is one of the embodiments as shown by some of the screen shots for mobile based reservation system implemented on the open mobile platform based on the “Android” platform. It is automatically linked and will interact dynamically and directly with our online reservation and ordering web site, which is used as an example for the aggregation web portal hosted on an Internet server that will process and relay all the message and information between the consumers and the businesses.

FIG. (7a) is the screen shot of the reservation screen after the list of restaurants have been sent back to the mobile phone by the Internet server to allow customer to select one of the restaurants before submitting reservation request.

FIG. (7b) is the screen shot of the reservation screen after the one of the restaurants from the list has been selected for making reservations.

FIG. (7c) is the screen shot of the reservation screen to allow customer to input their information before submitting reservation request.

FIG. (7d) is the screen shot of the reservation screen to show the reservation in progress, meaning the request has been sent to the business owner and waiting for response back from the restaurant after submitting the reservation request.

FIG. (7e) is the screen shot of the typical mobile phone application home screen, where two of the applications are from this invention: the “Reminder” icon and the “Restaurant” icon.

FIG. (7f) is the screen shot of the mobile event reminder system, where there is no event in the reminder system.

FIG. (7g) is the screen shot of the mobile event reminder system, where there are two events in the reminder system: one is the personal event input by the user directly, and the other is the event related to the restaurant reservation made before and the data and information are saved into the event reminder automatically without the need for redundant manual input by the user.

FIG. (7h) is the screen shot of the mobile event reminder system, when one of the events is highlighted by the user. The brief description is shown below for a quick reference.

FIG. (7i) is the screen shot of the mobile event reminder system, when one of the events is selected and the button is pushed by the user. The detailed description of the events and all the relevant information including the link to the Google map is therefore shown on the screen.

FIG. (7j) is the screen shot of the mobile event reminder system, when one of the events is selected and the button is pushed by the user. The detailed description of the events and all the relevant information including the link to the Google map is therefore shown on the screen. Please note this is another example of the reminder system where the event is not related to the restaurant ordering and reservation. It is only a personal event that needs to be notified prior to the event.

FIG. (7k) is the screen shot of the mobile event reminder system, when some of the features and available functions are shown and available for use by the users when setting up the notification and alarms prior to any event. It allows the user to create, input, modify, delete and save the events, sort by time and title in the notification and reminder system.

Claims by this Invention:

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the present invention.

What is claimed is:

1. A fully integrated mobile and online service platform, comprising of mobile and online ordering, reservation and notification systems that can operate either separately, or combined together, in order to suit to the different needs and tastes of each of business owners or end consumers.

2. Additionally or optionally, the mobile and the online service platform of claim 1, wherein: said platform provides a plural of new services and new applications with the newly developed “mobile and online based ordering and reservation system” by integrating, synchronizing and utilizing the capability of wireless devices, Internet servers, business web sites and service aggregation portals, to automate the mobile and online ordering and reservation processes in real time fashion.
The said platform utilizes the Internet server which will serve as the host to service aggregation and also as the intermediary device between customers and businesses. It will automatically synchronizes all of the services requests and responses in real time asynchronously among the end consumers requesting for services and the businesses providing the requested services, who are using either wireless devices or computers. The platform allows the end consumers to get all the information, history, details, status, billing, directly from the Internet server by simply requesting such information from the mobile phone, and the Internet servers will then process the request and obtain all the information and then send them back to the mobile phone of the consumer. It also allows the business owners to perform the similar request and to get the information and data they want that are relevant to their restaurants for all the ordering and reservations to their restaurants and related history and billing information.

3. Additionally or optionally, the mobile and the online service platform of claim 1, wherein: said platform allows the businesses to use various communication devices, such as computers, mobile phones, as well as other types of communication devices such as Internet Fax or network attached printers as the receiving devices. The Internet server will receive, process, forward, and synchronize all customer requests and all business responses, transfer message and data in between and update statuses to both customers and businesses, all in real time automatically.
The said platform supports a plural of message states for each message communicated between the customer and the business owner. These different states are indications of the status of the customer request and business response are in so that it can be tracked and carefully handled by the Internet server. Therefore the communication between the customer and the business is not only real time, but with many states control mechanism implemented to facilitate the communications and the understanding of the next actions to be taken or responses needed. For example, the status of a reservation request can be set in “pending”, “not available”, “rejected”, “confirmed”, “cancelled”, “closed”, “show up”, “no show” and etc. The states are correlated and dependent in given ways so that both the customers and businesses can review and act upon them.

4. Additionally or optionally, the mobile and the online service platform of claim 1, wherein: said platform supports a plural of the newly proposed and developed services at the Internet server, as well as a plural of newly proposed and developed applications for the wireless devices and the Internet attached computers, all supported by a new way of synchronization between the Internet infrastructure and wireless networks. This platform takes full advantage of the flexibility, mobility, availability and convenience of the wireless devices, and the reliability, scalability, the huge processing power of the Internet servers, and the great broadband penetration of the computers into businesses and consumers.

5. Additionally or optionally, the mobile and the online service platform of claim 1, wherein: said platform provides a unique and novel, mobile and online based ordering and reservation platform and system, for time sensitive services, and provides the mobile phone and Internet users and various types of business owners with comprehensive sets of options to deliver the requests and responses automatically and instantly through means of synchronization between mobile and Internet communications.
The said platform allows both the customers and the business owners to have many different options in choosing different means of communication devices when utilizing this system for the requested or provided services. For customers, the most convenient options are mobile phones and computers. For business owners, more options are available such as mobile phones, computers, fax machines, and network attached printers.

6. Additionally or optionally, the mobile and the online service platform of claim 1, wherein: said platform, among the sets of available options to the mobile phone users and the business owners, fully utilizes the capability of the mobile devices equipped with the “Android” software platform, which is an open source mobile phone platform based on the Linux operating system and developed by the Open Handset Alliance (OHA). One of the examples will be the release of mobile phone platform from the company like “Google”, the “gphone” that comes with the “Android” software platform installed. The said platform is based on the open source mobile phone platform and the Internet server infrastructure, and therefore provides an intuitive and easy-to-use mobile phone and online based ordering and reservation management system uniquely defined in the system to allow both the business owners and end consumers for the real time communications, to request for ordering and reservation services and to respond accordingly to such services in real time.

7. Additionally or optionally, the mobile and the online service platform of claim 1, wherein: said platform provides a comprehensive mobile phone and computer based order and reservation system intended for all industries and applications that are suitable and applicable. There is no limit where those systems shall be used efficiently and effectively. The said platform is, in particular, applied directly to the mobile phone based order and reservation to the restaurants, Pizza stores, and all food preparation and/or delivery business, as well as to other industries not relevant. It can also be applied to all the entertainment business and/or other businesses suited to the daily need of people, such as hair cut, salons and spas, massage center, bars, entertainment places, sporting facilities and etc.

8. Additionally or optionally, the mobile and the online service platform of claim 1, wherein: said platform is designed in such to be an interactive system that integrates the open module platform based on “Android” system and the aggregation web portal site to aggregate all the businesses together which is utilizing one of the unique features, and the mobile and online services provided by this integrated ordering reservation and notification system.

9. Additionally or optionally, the mobile and the online service platform of claim 1, wherein: said platform is designed in such to be also portable and suitable for supporting the exactly the same services on the customized web site owned by the business owners as those on the aggregated online web portal sites. It also supports the end consumers and the business owners to utilize the open mobile platform, in conjunction with the aggregation web portal sites to enable the mobile based time sensitive ordering and reservation services.

10. Additionally or optionally, the mobile and the online service platform of claim 1, wherein: said platform integrates the mobile and online ordering and reservation services with the mobile phone based event notification and reminder applications automatically so that the user will be able to set the alarm according to what he likes to set for each ordering and reservation event. The said platform integrates the mobile ordering and reservation system with the map search features, such as those from Google map search. The said platform also integrates the mobile and online ordering and reservation system with the local mobile phone based contact list stored on the phone, so that user can take full advantage of the contact list in his mobile phones for the restaurants and other business contacts. The said platform integrates also the mobile and online services into one efficient operation, and at the same time, allows mobile based ordering and reservation to work independently, which means user can use “Android” enabled open mobile phone to do all the ordering and reservation.

11. Additionally or optionally, the mobile and the online service platform of claim 1, wherein: said platform integrates the mobile and online services into one efficient operation, and at the same time, allows online based ordering and reservation to work independently, which means user can use any Internet connected computer to do all the ordering and reservation without the need of mobile phones. Additionally or optionally, the mobile and the online service platform of claim 1, wherein: said platform integrates the mobile and online services into one efficient operation, and at the same time, allows mobile based ordering and reservation to work independently, which means user can use any mobile phone to do all the ordering and reservation, either through the use of the application package based on the “Android” open mobile platform, or through the use of the online ordering and reservation package by surfing the aggregation web portal or any individual business's web site with the online service enabled by our application and service agreement.

12. Additionally or optionally, the mobile and the online service platform of claim 1, wherein: said platform is designed in such to support the sending of mobile or the online requests to the business owners instantly through the use of the instant notifications of Instant Messaging System (IMS) by mobile devices. That means, the business owners, the end consumers, and the Internet service platform operators will all be notified by the instant messages to their pre-selected mobile devices. Although the end consumers have the option to provide mobile phone number at their choice, the business owners and the platform operators can always get the instant notifications any time anywhere through multiple mobile devices, as long as the business owners are willing to utilize this service. This is not exclusive to other means of notifications. It is only one of the options for business owners on the go.
Additionally or optionally, the mobile and the online service platform of claim 1, wherein: said platform is designed in such to support the sending of mobile and the online requests to the business floor managers instantly through the use of the instant notifications of automatic Internet based fax capability, utilizing the existing fax machine and fax line inside the business, such as at the restaurant front desk or its office. This option is again used either separately or combined with all other means of notifications. This option will allow the floor manager or people on duty to receive the hard copy instantly with all the online request details so that they can handle the mobile and the online requests immediately after receiving it.
Additionally or optionally, the mobile and the online service platform of claim 1, wherein: said platform is designed in such to support the sending of mobile and the online requests to the business floor managers instantly through the use of the instant notifications of automatic printing by a network attached printer inside the business, normally at the front desk of the restaurant or at the manager's office. The printer can be the one attached to a computer connected to the Internet, or a standalone printer directly connected to the Internet through its own build in networking capability. Again this option is in addition to all other means and can be used either separately or combined with others. The printer can be a POS (point of sales) printer which can print out the online request in a label (using label printer) so that the business (in this case restaurant) can use the label directly as a traveling label for either the kitchen, the book keeping assistant, or the delivery agent, or the customer self pick up as well.
Additionally or optionally, the mobile and the online service platform of claim 1, wherein: said platform is designed in such to support the sending of the mobile and the online requests to the business floor managers instantly through the use of the instant notifications of Internet. The manager or the owners, once signed up with the Internet service, shall have a login account either with the Internet online service platform and the related web portal, or the mobile platform on their mobile phones enabled with such “mobile ordering, reservation and notification system”. After either the login in through Internet, or the downloading of information through the mobile phones, they will be able to see all the mobile or online requests anytime, anywhere, and can then respond to the mobile or online request through a number of very convenient and easy to use functions to the end consumers instantly through the Internet or mobile phones This notification is always present regardless what other means of notifications the business owners have chosen, in addition to this. Therefore, the business owners can always look into their mobile and the online requests, for the present, pending, past, and total requests ever occurred and delivered to their business. The end consumers can also optionally choose to sign in before making the mobile or the online requests so that he/she can also either review the information on his/her mobile phones or login in and check all the status from anywhere at any time.
Additionally or optionally, the mobile and the online service platform of claim 1, wherein: said platform is designed in such to support the sending of mobile and online requests to the business floor managers instantly through the use of the instant notifications of emails. The manager or the owners, once signed with the Internet service, shall receive the notification emails to the email addresses he/she designates, normally at the multiple business email addresses. Again, the email notification is always present and can be accessed anytime. Normally, this type of notification is in addition to other means of notifications, such as the use of Instant Messaging to mobile phones. All mobile phones can be set with different distinct ring music or tones to notify the business owners or floor managers that a mobile or online request has arrived and should be handled accordingly.

13. Additionally or optionally, the mobile and the online service platform of claim 1, wherein: said platform is designed in such to support the interactive actions required to communicate between the end consumers and the business owners. Both of them can access all information through the Internet and can communicate with each other through simple to use interface to send requests to the business, to respond to the customers, to update the status, and to check on the status form the business. This interactive feature allows the use of Internet and the mobile communication systems to achieve real time instant notifications to both sides without the hassle of calling back and forth and without the difficulty to communicate sometimes due to the language barriers coupled with some dialects or strong accent from one party or both sides.

14. Additionally or optionally, the mobile and the online service platform of claim 1, wherein: said platform is designed in such to support the unique “mobile and online ordering sheet” feature that mimics the real process inside a restaurant, when customers are ordering food at the spot inside the restaurant. This feature is like a real waitress waiting to write down what you like to order and you can also edit at any time during the mobile and online order process. It is a much more convenient feature to use compared with the so called “shopping cart” online. The “mobile and online ordering sheet” is persistent on the ordering page regardless how the customers are going back and forth to different pages to surf for the menus and search for the dishes, and is always visible all the time with all the information on the portion of the screen. It can also be hidden if the customer wishes to do so by just one click, and vice versa to expand it again to full view. It does not occupy the entire mobile or computer screen and all other menus items can still be fully visible and operational with the presence of “mobile and online ordering sheet” on portion of the screen.
Additionally or optionally, the mobile and the online service platform of claim 1, wherein: said platform is designed in such to support the unique “mobile and online ordering with coupon” feature that offers the end consumers the benefits of coupon but without the hassle to obtain a hard copy of the coupon through different means and try to keep tracking of them. With mobile and online order coupled with coupon built in the process, the customer can enjoy the convenience brought by the Internet and mobile communication systems. They can use the coupon anytime and anywhere they want without going the extreme to try to find one hard copy at the time when they really need it. Very often, they just simply cannot find it even they have one in their drawer beforehand.
The “mobile and online ordering with coupon” also brings in benefits to the business owners to provide them with the flexibility to add, modify, and even delete the coupons at any time, while giving them a lot of savings to their marketing cost. The “mobile and online ordering with coupon” feature supports very complex algorithm inside the database, but offers simplicity to users.
It supports a variety of coupon types. For example, it supports a simple discount rate for all food ordered, or a specially discounted food if certain conditions in the regular food ordering process is satisfied. For example, if the regularly ordered food amount is beyond certain amount, some other foods will be either free or only half of the original price. The feature also supports customized coupon ordering, such in the case of Pizza ordering. The coupon can be a special type of Pizza with customer chosen compositions, such as different sizes, toppings, number of Pizzas, all of them can be customer selected when ordering the Pizza based on coupon.
Additionally or optionally, the mobile and the online service platform of claim 1, wherein: said platform is designed in such to support the unique “group and corporate mobile and online ordering” feature that offers the group users and corporate users the much needed convenience and benefits that the regular individual users may not need.
Each group and corporate can order using one ordering sheet, under one group or corporate, to be delivered to the same address at the same time, or to be picked up by one person, but all the dishes are either ordered by each individual in the group or corporation, or the organizer on behave of them. However, each dish is labeled differently so that the business owner and also the organizer will know which dish is for whom and what will be the special treatment to each of the dish ordered. The group and the corporate can also sign up for the service that will be able to handle all the billings and tracking as well as the expense report for the group and corporation.
Additionally or optionally, the mobile and the online service platform of claim 1, wherein: said platform is designed in such to support the “mobile and online ordering menu with dual languages support” feature that offers much better user experiences and facilitates the mobile and the online order process, which addresses to a much larger population of end consumers and business owners. It addresses the distinct nature of restaurant industry or any other industries that have the same characteristics. Now each dish is provided with two languages, one is for English, and the other is for the native language used for the dish, which conveys the true taste of the dishes to the customers with the native language background.
Additionally or optionally, the mobile and the online service platform of claim 1, wherein: said platform is designed in such to support the “mobile and online ordering menu with individual note and label” feature that offers much better user experiences and facilitates the mobile and online order process. With this flexibility, the customer can now specify for each dish what they would like to be processed in the restaurant, such as “more spicy” or “no pepper please”. This again tunes to the individual taste which is what the restaurant business is all about. It also allows the group or corporate ordering to label each dish for each of the designated end consumers, whether for group delivery or self pickup for the group.
Additionally or optionally, the mobile and the online service platform of claim 1, wherein: said platform is designed in such to support the “mobile and online service with periodic statistical analysis and billing” feature that offers much better handling of the mobile and online service to the business owners. They can now have all the access to their own data and can produce all the summary report at their finger tips on periodic basis with all the tools and buttons provided by the mobile or the online service. They can review their monthly or quarterly billing information, and the customer mobile and online request statistics.
Additionally or optionally, the mobile and the online service platform of claim 1, wherein: said platform is designed in such to support the “mobile and online web site service with automatic menu loading and self editing” feature that offers much better handling of the mobile and online order service to the business owners. They can now have all the access to their own mobile and online menu and be able to modify them as they see the needs. An easy to access interface will provide them the ability to change and modify the mobile or online menu so that they can revise the mobile and the online order menu regularly and still be able to allow the end consumer to continue to order the food. On their side, it is time saving, money saving and hassle free option they can enjoy.
Additionally or optionally, the mobile and online service platform of claim 1, wherein: said platform is designed in such to support the “mobile and online reservation” feature that offers very intuitive approach to the end users and also to the business owners. An update calendar will also be handy to the users, and the instant notifications to the owners make sure that the owners will be able to get the reservation anytime, anywhere, even when the business is closed for the day or for the time. So the consumers will not worry when to call and how to reach the business owner to confirm the reservation, since most of the reservation is made during off work time, and likely at night from home.
On the other hand, this feature allows the owner to respond to the customer by one or two simple clicks only. At the same time, the owner can respond to the customer reservation by cell phone in case he/she is out and the reservation is urgently to be confirmed. A full automatic response is made possible without owner's involvement as long as the owner has signed up for the service. The system will be able to search for the capacity in the restaurant and then decide automatically for the restaurant and then send back the response to the customer instantly.
Additionally or optionally, the mobile and the online service platform of claim 1, wherein: said platform is designed in such to support the “mobile and online reservation with advanced ordering” feature that offers very innovative approach to the end users and also to the business owners. When corporate users or even individual users make the reservation ahead of time for some important business meetings or symbolic celebrations, sometimes the timing is critical and the purpose is more for business arrangement, or other reasons. People would like to have a very decent food, all ordered in advance, prepared by the restaurant right before the arrival of the guests, so there will be no waiting in getting the table, the services and as well as their favorite dishes.
The purpose of advanced reservation is to make sure to get the seats, but sometime, it is critical to also get the foods ready on time so there is not much of waiting, especially for the popular restaurants, where sometimes the waiting for food is very long at a good time or holiday season. This “advanced ordering” feature along with reservation addresses this issue and help the customer and business owner to work together to arrange for the upcoming events flawlessly.
The organizer can utilize the “group or corporate mobile and online ordering” feature and the “mobile and online ordering menu with individual notes and label” feature to place the advance food order for the upcoming party, when he/she makes the “mobile and online reservation” at the time. This is an excellent example how our fully integrated mobile and online order and reservation system working together to meet the daily demand of real customers and to solve the problems facing the business owners.
Additionally or optionally, the mobile and the online service platform of claim 1, wherein: said platform is designed in such to support the “mobile and online catering” feature that offers the much needed mobile and online service model to the restaurant industry. “Mobile and online catering” is a comprehensive platform that gives the customers and the business owners the ability to share the platform and communicate interactively with each other to prepare a catering event for the customer.
It allows the reservation, ordering, modification, and tracking to the catering request either online or through the mobile phones by the customers. It also allows the business owners to respond to the mobile or the online catering request, to modify the offerings and change the pricing, vary the pricing level, and add additional offerings or coupons/gifts items to the catering events, while negotiate the entire package on time. It allows the customers or business owners to have their internal reviews with all the available information anytime they need it. It eliminates many of the tedious and time consuming, error prone calculations and tracking to both sides. It saves the time to the customers for filing expense reports. It also allows the owners to track the business record and analyze the profit and cost accurately. It is an innovated approach to address the old business for the first time.
Additionally or optionally, the mobile and the online service platform of claim 1, wherein: said platform is designed in such to support the “mobile and online interactive blogging” feature that offers both the end consumers to write comments about the service of the business and also allows the business owners to respond back to the associated comments. It also allows the mobile ordering and reservation service operators or the online service operators to monitor and moderate the blogging process to eliminate the junk or harmful information. This platform provides bidirectional blogging capability and also clearly identifies the business owners as the responsible responders to all the comments of the business service. This is unique and novel in this Internet and mobile business and will make our mobile and online service distinct from others.
Additionally or optionally, the mobile and the online service platform of claim 1, wherein: said platform is designed in such to support the “mobile and online ranking by mobile and online order and reservation customers” feature that offers the real mobile and online customers to rank the service received, the food, the environment, and etc. This eliminates junk ranking, unfair statement, and therefore establishes the real credibility within the user community and provides enormous feedback to the business owners. In addition, it provides good reference to other consumers, and to the mobile and online service operators.

15. A fully integrated comprehensive mobile and online service platform, comprising of mobile and online ordering, reservation and notification systems that can offer some or all of the above features described and claimed above, and applied to different business segments other than restaurant industry. It can be used for the other industries that may also touch on the daily life of people, on all activities such as the hair cut reservation, salons and spas reservation, massage reservation, sports facility reservation, public facility or private facility reservation, reservation for students or parents to meet the school teachers for any specific reasons, reservation for going to the bar, attending entertainment events or gatherings, or reservation for a child birthday party at certain places and facilities, and ordering of birthday party gift packages for the party reservations, and etc. The list can go on and is not limited to the ones mentioned above. The key is to utilize the new fully integrated platform to maximize the benefits it brings in to the customers and to the business owners alike.
For many of the activities mentioned above, mobile or online reservation is a preferred choice, and at the same time, many of them requires mobile or online ordering as well to prepare for the events. For example, reservation of the birthday party may means also the need to place advanced mobile or online order of gift cards, gift packages, and some special goody bags for the birthday parties. Our integrated system shall then be ideal to be used by the business owner to put onto their web sites for the convenience of their customers.
Additionally, the systems can be applied to different countries with different languages to serve to different populations and special needs. For example, this platform can be fully converted into a Chinese version so that it can serve the Chinese community in China, or the Chinese speaker community in US or in any other countries. It can of course be used in any other languages for any other countries or any other specific ethic communities in certain countries or regions.
Additionally or optionally, this system can be implemented in many ways, including but not limited to the use of either fully centralized database systems, or localized distributed database systems, or the combination of centralized database systems (server side) and localized database systems (client side) on the database side. It can be implemented in different types of mobile phones, using either the mobile based web access, or using the open mobile platform based on “Android” platform and installed with our “mobile ordering, reservation and notification system” for the interaction between the mobile system and the Internet aggregation portal sites (aggregation servers).
Additionally or optionally, this system can also be implemented in many ways, including but not limited to the use of photos, flash video, and real or marketing video clips based on streaming techniques to showcase the environment of the associated business, its history and present status, its environment, its management and people, its current offerings, and its individual items (such as dishes), and even some customer testimonials. Each of the business and its web site listed on the aggregation web sites can be supported via the advanced video streaming technologies to make the mobile and the online service more intuitive, interactive, and more appealing to the customers.
Additionally or optionally, this system can be implemented in many ways, including but not limited to the use of web site design technologies specifically suitable for mobile and PDA devices with a smaller screen, to support the mobile and online ordering, catering, and reservation, as well as all other services, for people on the go who like to request the online order/catering/reservation and etc. from their mobile devices and PDA devices.

16. A fully integrated comprehensive mobile and online order and reservation service platform, comprising of mobile and online ordering, catering, and reservation systems that can offer some or all of the above features described and claimed above, and can be implemented in many ways, including but not limited to the support of customers who may have no access to Internet when they are on the go, but would like to make advanced reservation or ordering as well. In this case, our implementation includes but not limited to the support of use of the advanced open mobile platform based “ordering, reservation and notification system”, or the traditional mobile phone based Instant Messaging by the end customers from a mobile or PDA device. When the customer sends the Instant Messaging to the mobile and online service platform, the centralized server will be able to receive the Instant Message, and then decode the message, and select the request information to the customers to help him/her to decide which mobile or online request or what types of mobile or online request should be sent on behave of him or her. If the information is not sufficient to help the consumer to make the final decision, new instant message will be sent to the customer to ask for more input or clarifications, or sent more requested information to the customer, so he/she can make a decision. Once the customer has decided what he/she needs and confirmed to the mobile or the online service platform, the mobile and the online service platform will then send the mobile or the online request on behave of him to the business owners (or restaurants) to request the mobile or online service, and at the same time, send the instant message back to the customer to copy him/her as well, as the proof of mobile and online request and also as the information for him/her to follow up accordingly.
